(19) United States
(12) Patent Application Publication
(10) Pub. No.: US 2009/0299756 A1
(43) Pub. Date: Dec. 3, 2009

(54) Ratio of speech to non-speech audio such as for elderly or hearing-impaired listeners

(75) Inventors: Mark Franklin Davis, Pacifica, CA (US); Michael John Smithers, Kareela (AU)

Correspondence Address: Dolby Laboratories Inc., 999 Brannan Street, San Francisco, CA, 94103, US

(73) Assignee: Dolby Laboratories Licensing Corporation, San Francisco, CA (US)

(21) Appl. No.: 12/283,712

(22) Filed: Sep. 12, 2008

Related U.S. Application Data
(63) Continuation of application No. PCT/US2007/007054, filed on Mar. 21, 2007.
Application No. PCT/US2007/007054 is a continuation-in-part of application No. 10/591,374, filed on Aug. 31, 2006.
(60) Provisional application No. 60/784,551, filed on Mar. 21, 2006.
(60) Provisional application No. 60/549,368, filed on Mar. 1, 2004.
(60) Provisional application No. 60/579,974, filed on Jun. 14, 2004.
(60) Provisional application No. 60/588,256, filed on Jul. 14, 2004.

(51) Int. Cl. G10L 21/00

(52) U.S. Cl. 704/500

(57) ABSTRACT

A hybrid stereophonic/monophonic audio signal encoding comprises generating, in response to a discrete two-channel stereophonic audio signal, an encoded hybrid stereophonic/monophonic audio signal in which the audio signal is a discrete two-channel audio signal below a frequency fₘ and a single-channel monophonic audio signal above the frequency fₘ, generating, in response to the discrete two-channel stereophonic audio signal, spatial parameter information characterizing the discrete two-channel stereophonic audio signal above the frequency fₘ, and combining the hybrid stereophonic/monophonic audio signal with said spatial parameter information in such a manner that the resulting signal is decodable both by a decoder configured to decode a discrete two-channel stereophonic audio signal encoded with the same encoding as applied to the hybrid stereophonic/monophonic audio signal and by a decoder configured to decode, with the use of the spatial parameter information, the hybrid stereophonic/monophonic audio signal. A hybrid stereophonic/monophonic audio signal decoding is also provided.

### CROSS-REFERENCE TO RELATED APPLICATIONS

This application is a continuation of International Patent Application No. PCT/US2007/007054, filed Mar. 21, 2007, which, in turn, claims priority of U.S. provisional Patent Application Ser. No. 60/784,551, filed Mar. 21, 2006. This application is also a continuation-in-part of U.S. patent application Ser. No. 10/591,374, filed Aug. 31, 2006, which is the national stage application under 35 U.S.C. 371 of International Patent Application No. PCT/US2005/006359, filed Feb. 28, 2005, which, in turn, claims priority of U.S. provisional Patent Applications Ser. No. 60/549,368, filed Mar. 1, 2004; Ser. No. 60/579,974, filed Jun. 14, 2004; Ser. No. 60/588,256, filed Jul. 14, 2004 and Ser. No. 60/784,551, filed Mar. 21, 2006.

### TECHNICAL FIELD

The invention relates generally to audio signal processing. More particularly, aspects of the invention relate to an encoder (or encoding process), a decoder (or decoding processes), and to an encode/decode system (or encoding/decoding process) for audio signals with a very low bit rate in which a plurality of audio channels is represented by a composite monophonic audio channel and auxiliary (“sidechain”) information. Alternatively, the plurality of audio channels are represented by a plurality of audio channels and sidechain information. Aspects of the invention also relate to a multichannel to composite monophonic channel downmixer (or downmix process), to a monophonic channel to multichannel upmixer (or upmixer process), and to a monophonic channel to multichannel decorrelator (or decorrelation process). Other aspects of the invention relate to a multichannel to multichannel downmixer (or downmix process), to a multichannel to multichannel upmixer (or upmix process), and to a decorrelator (or decorrelation process).

### BACKGROUND ART

In the AC-3 digital audio encoding and decoding system, channels may be selectively combined or “coupled” at high frequencies when the system becomes starved for bits. Details of the AC-3 system are well known in the art—see, for example: ATSC Standard A52/A: Digital Audio Compression Standard (AC-3), Revision A, Advanced Television Systems Committee, 20 Aug. 2001. The A/52A document is available on the World Wide Web at http://www.atsc.org/standards.html. The A/52A document is hereby incorporated by reference in its entirety.

The frequency above which the AC-3 system combines channels on demand is referred to as the “coupling” frequency. Above the coupling frequency, the coupled channels are combined into a “coupling” or composite channel. The encoder generates “coupling coordinates” (amplitude scale factors) for each subband above the coupling frequency in each channel. The coupling coordinates indicate the ratio of the original energy of each coupled channel subband to the energy of the corresponding subband in the composite channel. Below the coupling frequency, channels are encoded discretely. The phase polarity of a coupled channel's subband may be reversed before the channel is combined with one or more other coupled channels in order to reduce out-of-phase signal component cancellation. The composite channel along with sidechain information that includes, on a per-subband basis, the coupling coordinates and whether the channel's phase is inverted, are sent to the decoder. In practice, the coupling frequencies employed in commercial embodiments of the AC-3 system have ranged from about 10 kHz to about 3500 Hz. U.S. Pat. Nos. 5,583,963; 5,633,981, 5,727,119, 5,909,664, and 6,021,386 include teachings that relate to the combining of multiple audio channels into a composite channel and auxiliary or sidechain information and the recovery therefrom of an approximation to the original multiple channels. Each of said patents is hereby incorporated by reference in its entirety.

### SUMMARY OF THE INVENTION

Aspects of the present invention may be viewed as improvements upon the “coupling” techniques of the AC-3 encoding and decoding system and also upon other techniques in which multiple channels of audio are combined either to a monophonic composite signal or to multiple channels of audio along with related auxiliary information and from which multiple channels of audio are reconstructed. Aspects of the present invention also may be viewed as improvements upon techniques for downmixing multiple audio channels to a monophonic audio signal or to multiple audio channels and for decorrelating multiple audio channels derived from a monophonic audio channel or from multiple audio channels.

Aspects of the invention may be employed in an N:1:N spatial audio coding technique (where “N” is the number of audio channels) or an M:1:N spatial audio coding technique (where “M” is the number of encoded audio channels and “N” is the number of decoded audio channels) that improve on channel coupling, by providing, among other things, improved phase compensation, decorrelation mechanisms, signal dependent variable time constants, and more compact amplitude representation. Aspects of the present invention may also be employed in N:x:N and M:x:N spatial audio coding techniques wherein “x” may be 1 or greater than 1. Goals include the reduction of coupling cancellation artifacts in the encode process by adjusting interchannel phase shift before downmixing, and improving the spatial dimensionality of the reproduced signal by restoring the phase angles and degrees of decorrelation in the decoder. Aspects of the invention when embodied in practical embodiments should allow for continuous rather than on-demand channel coupling and lower coupling frequencies than, for example in the AC-3 system, thereby reducing the required data rate.

### BRIEF DESCRIPTION OF THE DRAWINGS

FIG. 1 is an idealized block diagram showing the principal functions or devices of an N:1 encoding arrangement embodying aspects of the present invention.

FIG. 2 is an idealized block diagram showing the principal functions or devices of a 1:N decoding arrangement embodying aspects of the present invention.

FIG. 3 shows an example of a simplified conceptual organization of bins and subbands along a (vertical) frequency axis and blocks and a frame along a (horizontal) time axis. The figure is not to scale.

FIG. 4 is in the nature of a hybrid flowchart and functional block diagram showing encoding steps or devices performing functions of an encoding arrangement embodying aspects of the present invention.

FIG. 5 is in the nature of a hybrid flowchart and functional block diagram showing decoding steps or devices performing functions of a decoding arrangement embodying aspects of the present invention.

FIG. 6 is an idealized block diagram showing the principal functions or devices of a first N:x encoding arrangement embodying aspects of the present invention.

FIG. 7 is an idealized block diagram showing the principal functions or devices of an x:M decoding arrangement embodying aspects of the present invention.

FIG. 8 is an idealized block diagram showing the principal functions or devices of a first alternative x:M decoding arrangement embodying aspects of the present invention.

FIG. 9 is an idealized block diagram showing the principal functions or devices of a second alternative x:M decoding arrangement embodying aspects of the present invention.

FIG. 10 is an idealized block diagram showing the principle functions or devices of an augmented mono/stereo encoder or encoding function according to aspects of the invention.

FIG. 11 is an idealized block diagram showing the principle functions or devices of an alternative augmented mono/stereo encoder or encoding function according to aspects of the invention.

FIG. 12 is an idealized block diagram showing the principle functions or devices of an alternative augmented mono/stereo decoder or decoding function according to aspects of the invention.

### DETAILED DESCRIPTION OF EMBODIMENTS OF THE INVENTION

Basic N:1 Encoder

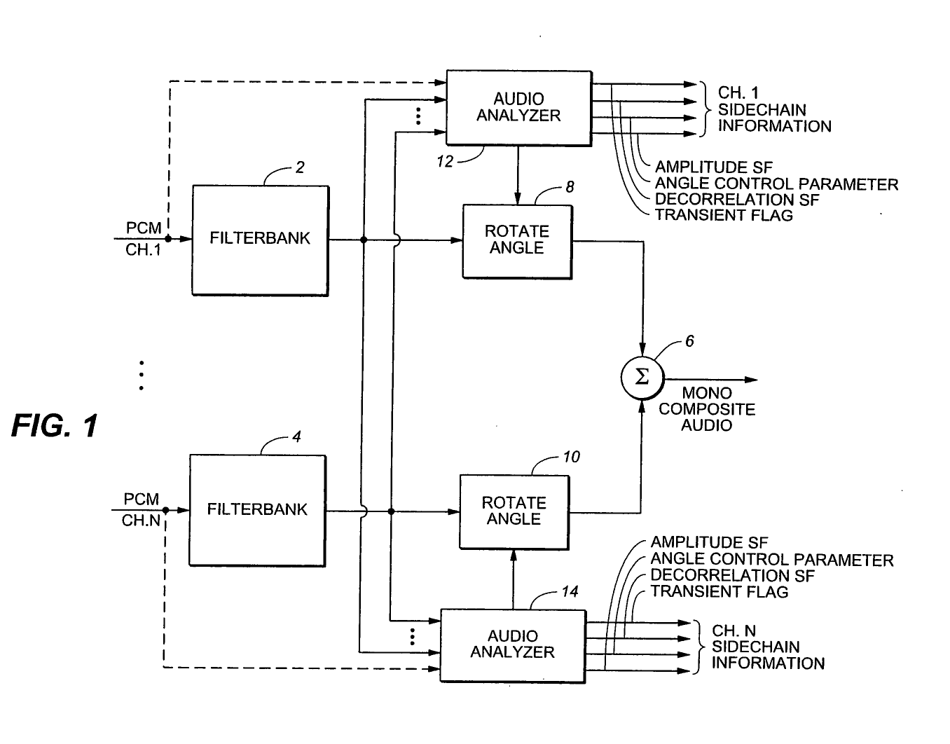

Referring to FIG. 1, an N:1 encoder function or device embodying aspects of the present invention is shown. The figure is an example of a function or structure that performs as a basic encoder embodying aspects of the invention. Other functional or structural arrangements that practice aspects of the invention may be employed, including alternative and/or equivalent functional or structural arrangements described below.

Two or more audio input channels are applied to the encoder. Although, in principle, aspects of the invention may be practiced by analog, digital or hybrid analog/digital embodiments, examples disclosed herein are digital embodiments. Thus, the input signals may be time samples that may have been derived from analog audio signals. The time samples may be encoded as linear pulse-code modulation (PCM) signals. Each linear PCM audio input channel is processed by a filterbank function or device having both an in-phase and a quadrature output, such as a 512-point windowed forward discrete Fourier transform (DFT) (as implemented by a Fast Fourier Transform (FFT)). The filterbank may be considered to be a time-domain to frequency-domain transform.

FIG. 1 shows a first PCM channel input (channel “1”) applied to a filterbank function or device, “filterbank” 2, and a second PCM channel input (channel “n”) applied, respectively, to another filterbank function or device, “filterbank” 4. There may be “n” input channels, where “n” is a whole positive integer equal to two or more. Thus, there also are “n” filterbanks, each receiving a unique one of the “n” input channels. For simplicity in presentation, FIG. 1 shows only two input channels, “1” and “n”.

When a filterbank is implemented by an FFT, signals are usually processed in overlapping blocks and the FFT's discrete frequency outputs (transform coefficients) are referred to as bins, each having a complex value with real and imaginary parts corresponding, respectively, to in-phase and quadrature components. Contiguous transform bins may be grouped into subbands approximating critical bandwidths of the human ear, and most sidechain information produced by the encoder, as will be described, may be calculated and transmitted on a per-subband basis in order to minimize processing resources and to reduce the bit rate. Multiple successive blocks may be grouped into frames, with individual block values averaged or otherwise combined or accumulated across each frame, to minimize the sidechain data rate. In examples described herein, each filterbank is implemented by an FFT, contiguous transform bins are grouped into subbands, blocks are grouped into frames and sidechain data is sent on a once per-frame basis. Alternatively, sidechain data may be sent on a more than once per frame basis. Obviously, there is a tradeoff between the frequency at which sidechain information is sent and the required bitrate.

A suitable practical implementation of aspects of the present invention may employ fixed length frames of about 32 milliseconds when a 48 kHz sampling rate is employed, each frame having six blocks of about 5.3 milliseconds each. However, neither such timings nor the employment of fixed length frames nor their division into a fixed number of blocks is critical to practicing aspects of the invention provided that information described herein as being sent on a per-frame basis is sent about every 20 to 40 milliseconds. Frames may be of arbitrary size and their size may vary dynamically. Variable block lengths may be employed as in the AC-3 system cited above. It is with that understanding that reference is made herein to “frames” and “blocks.” In practice, if the mono composite signal or the mono composite signal and discrete low-frequency channels are perceptually encoded, as described below, it is convenient to employ the same frame and block configuration as employed in the perceptual coder.

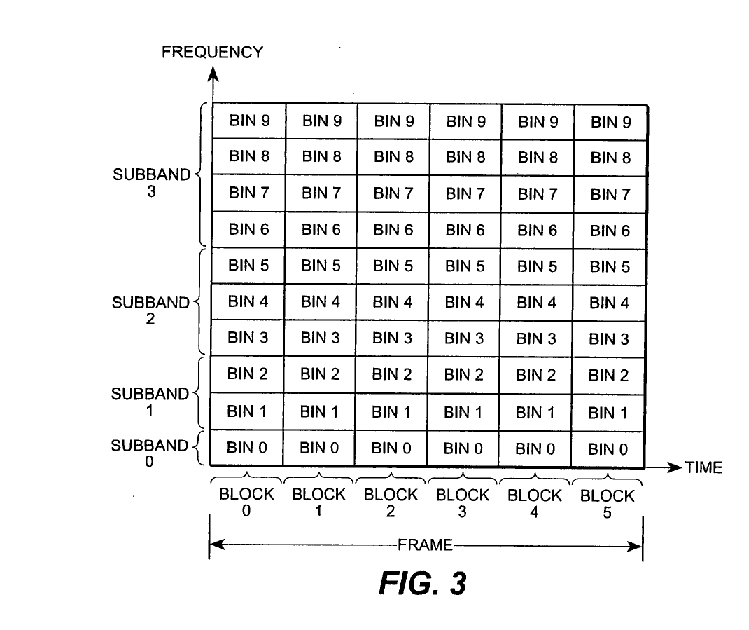

FIG. 3 shows an example of a simplified conceptual organization of bins and subbands along a (vertical) frequency axis and blocks and a frame along a (horizontal) time axis. When bins are divided into subbands that approximate critical bands, the lowest frequency subbands have the fewest bins (e.g., one) and the number of bins per subband increase with increasing frequency.

Returning to FIG. 1, a frequency-domain version of each of the n time-domain input channels, produced by the each channel's respective filterbank (filterbanks 2 and 4 in this example) are summed together (“downmixed”) to a monophonic (“mono”) composite audio signal by an additive combiner 6.

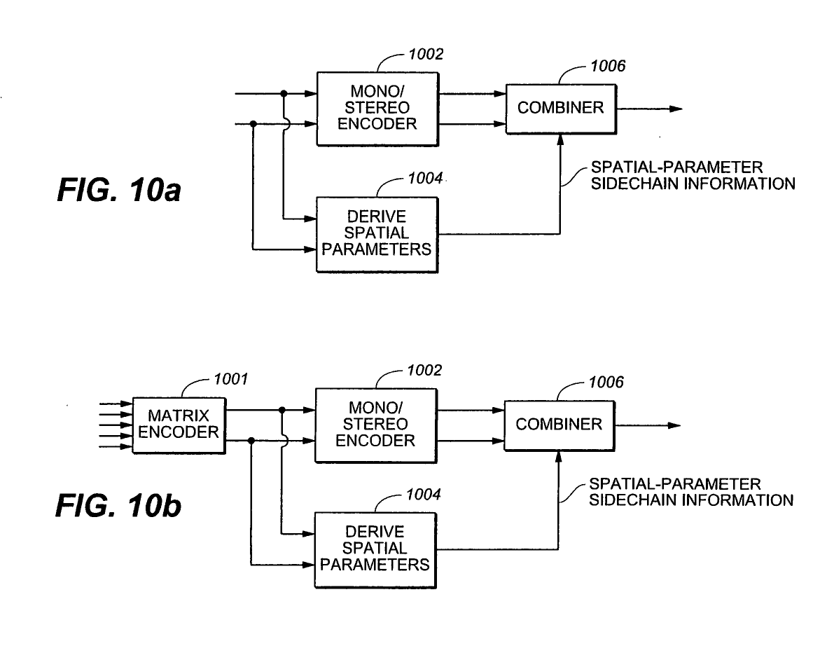

The downmixing may be applied to the entire frequency bandwidth of the input audio signals or, optionally, it may be limited to frequencies above a given “coupling” frequency, inasmuch as artifacts of the downmixing process may become more audible at middle to low frequencies. In such cases, the channels may be conveyed discretely below the coupling frequency. Such an arrangement is described below in connection with the examples of FIGS. 10, 11 and 12. This strategy may be desirable even if processing artifacts are not an issue, in that mid/low frequency subbands constructed by grouping transform bins into critical-band-like subbands (size roughly proportional to frequency) tend to have a small number of transform bins at low frequencies (one bin at very low frequencies) and may be directly coded with as few or fewer bits than is required to send a downmixed mono audio signal with sidechain information. In a practical embodiment of aspects of the present invention, a coupling frequency as low as 2300 Hz has been found to be suitable. However, the coupling frequency is not critical and lower coupling frequencies, even a coupling frequency at the bottom of the frequency band of the audio signals applied to the encoder, may be acceptable for some applications, particularly those in which a very low bit rate is important.

Before downmixing, it is an aspect of the present invention to improve the channels' phase angle alignments vis-á-vis each other, in order to reduce the cancellation of out-of-phase signal components when the channels are combined and to provide an improved mono composite channel. This may be accomplished by controllably shifting over time the “absolute angle” of some or all of the transform bins in ones of the channels. For example, all of the transform bins representing audio above a coupling frequency, thus defining a frequency band of interest, may be controllably shifted over time, as necessary, in every channel or, when one channel is used as a reference, in all but the reference channel.

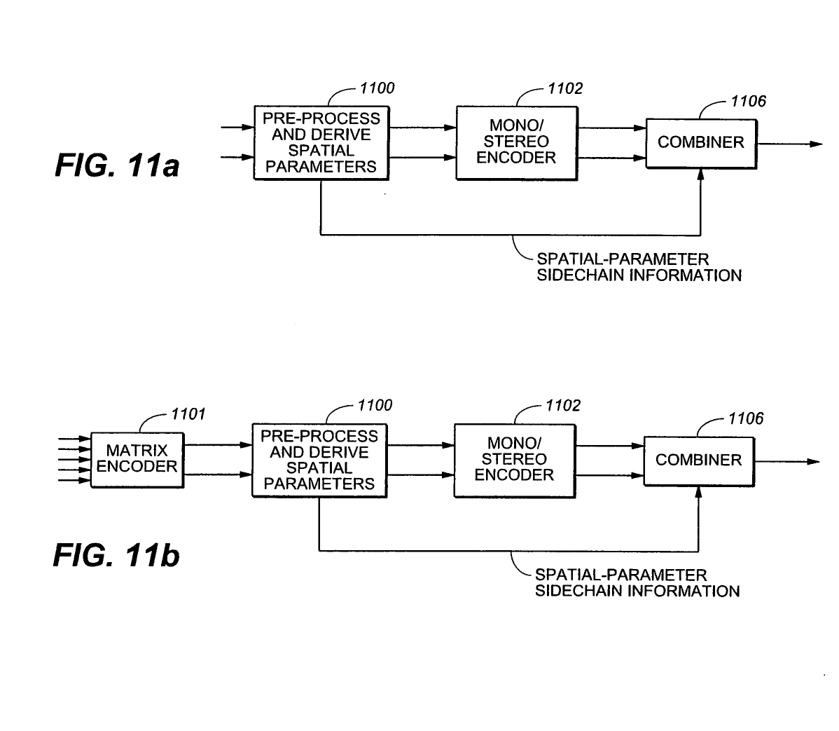

The “absolute angle” of a bin may be taken as the angle of the magnitude-and-angle representation of each complex valued transform bin produced by a filterbank. Controllable shifting of the absolute angles of bins in a channel is performed by an angle rotation function or device (“rotate angle”). Rotate angle 8 processes the output of filterbank 2 prior to its application to the downmix summation 6, while rotate angle 10 processes the output of filterbank 4 prior to its application to the downmix summation 6. It will be appreciated that, under some signal conditions, no angle rotation may be required for a particular transform bin over a time period (the time period of a frame, in examples described herein). Below the coupling frequency, the channel information may be encoded discretely (not shown in FIG. 1; see, for example, the examples of FIGS. 10 and 11, below).

In principle, an improvement in the channels' phase angle alignments with respect to each other may be accomplished by phase shifting every transform bin or subband by the negative of its absolute phase angle, in each block throughout the frequency band of interest. Although this substantially avoids cancellation of out-of-phase signal components, it tends to cause artifacts that may be audible, particularly if the resulting mono composite signal is listened to in isolation. Thus, it is desirable to employ the principle of “least treatment” by shifting the absolute angles of bins in a channel only as much as necessary to minimize out-of-phase cancellation in the downmix process and minimize spatial image collapse of the multichannel signals reconstituted by the decoder. A preferred technique for determining such angle shift is described below.

Energy normalization may also be performed on a per-bin basis in the encoder to reduce further any remaining out-of-phase cancellation of isolated bins, as described further below. Also as described further below, energy normalization may also be performed on a per-subband basis (in the decoder) to assure that the energy of the mono composite signal equals the sums of the energies of the contributing channels.

Each input channel has an audio analyzer function or device (“audio analyzer”) associated with it for generating the sidechain information for that channel and for controlling the amount of angle rotation applied to the channel before it is applied to the downmix summation 6. The filterbank outputs of channels 1 and n are applied to audio analyzer 12 and to audio analyzer 14, respectively. Audio analyzer 12 generates the sidechain information for channel 1 and the amount of angle rotation for channel 1. Audio analyzer 14 generates the sidechain information for channel n and the amount of angle rotation for channel n.

The sidechain information for each channel generated by an audio analyzer for each channel may include:
an Amplitude Scale Factor (“Amplitude SF”),
an Angle Control Parameter,
a Decorrelation Scale Factor (“Decorrelation SF”), and
a Transient Flag.
   In each case, the sidechain information applies to a single subband (except for the Transient Flag, which applies to all subbands within a channel) and may be updated once per frame as in the examples described below. The angle rotation for a particular channel in the encoder may be taken as the polarity-reversed Angle Control Parameter that forms part of the sidechain information.

If a reference channel is employed, that channel may not require an audio analyzer or, alternatively, may require an audio analyzer that generates only Amplitude Scale Factor sidechain information. It is not necessary to send an Amplitude Scale Factor if that scale factor can be deduced with sufficient accuracy by a decoder from the Amplitude Scale Factors of the other, non-reference, channels. It is possible to deduce in the decoder the approximate value of the reference channel's Amplitude Scale Factor if the energy normalization in the encoder assures that the scale factors across channels within any subband substantially sum square to 1, as described below. The deduced approximate reference channel Amplitude Scale Factor value may have errors as a result of the relatively coarse quantization of amplitude scale factors resulting in image shifts in the reproduced multi-channel audio. However, in a low data rate environment, such artifacts may be more acceptable than using the bits to send the reference channel's Amplitude Scale Factor. Nevertheless, in some cases it may be desirable to employ an audio analyzer for the reference channel that generates, at least, Amplitude Scale Factor sidechain information

FIG. 1 shows in a dashed line an optional input to each audio analyzer from the PCM time domain input to the audio analyzer in the channel. This input may be used by the audio analyzer to detect a transient over a time period (the period of a block or frame, in the examples described herein) and to generate a transient indicator (e.g., a one-bit “Transient Flag”) in response to a transient. Alternatively, as described below, a transient may be detected in the frequency domain, in which case the audio analyzer need not receive a time-domain input.

The mono composite audio signal and the sidechain information for all the channels (or all the channels except the reference channel) may be stored, transmitted, or stored and transmitted to a decoding process or device (“decoder”). Preliminary to the storage, transmission, or storage and transmission, the various audio signal and various sidechain information may be multiplexed and packed into one or more bitstreams suitable for the storage, transmission or storage and transmission medium or media. The mono composite audio may be applied to a data-rate reducing encoding process or device such as, for example, a perceptual encoder or to a perceptual encoder and an entropy coder (e.g., arithmetic or Huffman coder) (sometimes referred to as a “lossless” coder) prior to storage, transmission, or storage and transmission. Also, as mentioned above, the mono composite audio and related sidechain information may be derived from multiple input channels only for audio frequencies above a certain frequency (a “coupling” frequency). In that case, the audio frequencies below the coupling frequency in each of the multiple input channels may be stored, transmitted or stored and transmitted as discrete channels or may be combined or processed in some manner other than as described herein. Such discrete or otherwise-combined channels may also be applied to a data reducing encoding process or device such as, for example, a perceptual encoder or a perceptual encoder and an entropy encoder. The mono composite audio and the discrete multichannel audio may all be applied to an integrated perceptual encoding or perceptual and entropy encoding process or device. As described below in connection with examples of FIGS. 10, 11 and 12, the various sidechain information may be carried in what would otherwise have been unused bits or steganographically in an encoded version of the audio information.

Basic 1:N and 1:M Decoder

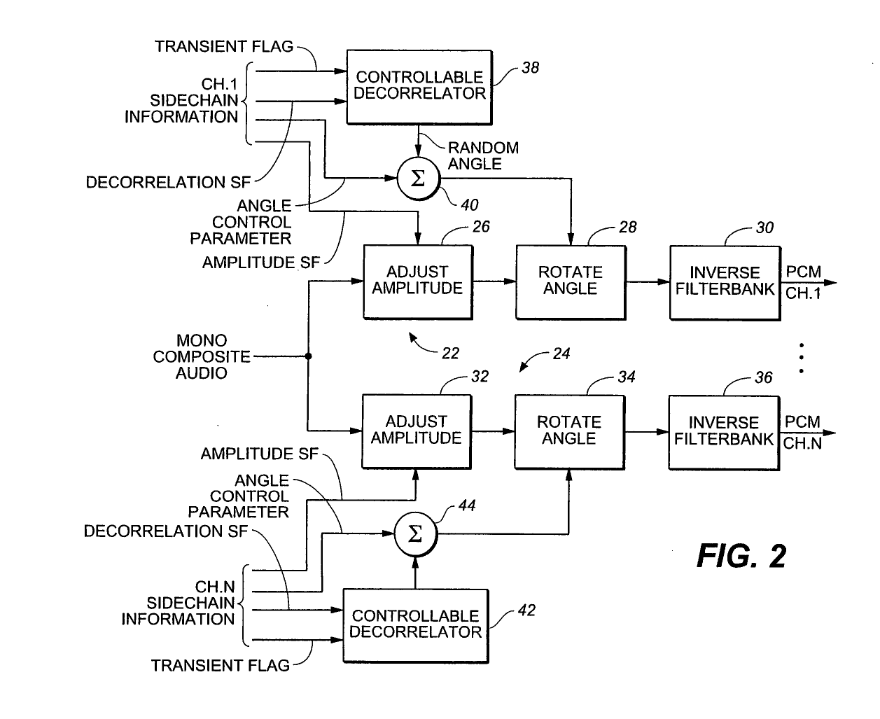

Referring to FIG. 2, a decoder function or device (“decoder”) embodying aspects of the present invention is shown. The figure is an example of a function or structure that performs as a basic decoder embodying aspects of the invention. Other functional or structural arrangements that practice aspects of the invention may be employed, including alternative and/or equivalent functional or structural arrangements described below.

The decoder receives the mono composite audio signal and the sidechain information for all the channels or all the channels except the reference channel. If necessary, the composite audio signal and related sidechain information is demultiplexed, unpacked and/or decoded. Decoding may employ a table lookup. The goal is to derive from the mono composite audio channels a plurality of individual audio channels approximating respective ones of the audio channels applied to the encoder of FIG. 1, subject to bitrate-reducing techniques of the present invention that are described herein.

Of course, one may choose not to recover all of the channels applied to the encoder or to use only the monophonic composite signal. Alternatively, channels in addition to the ones applied to the encoder may be derived from the output of a decoder according to aspects of the present invention by employing aspects of the inventions described in International Application PCT/US 02/03619, filed Feb. 7, 2002, published Aug. 15, 2002, designating the United States, and its resulting U.S. national application Ser. No. 10/46t7,213, filed Aug. 5, 2003, and in International Application PCT/U.S.03/24570, filed Aug. 6, 2003, published Mar. 4, 2001 as WO 2004/019656, designating the United States. Said applications are hereby incorporated by reference in their entirety. Channels recovered by a decoder practicing aspects of the present invention are particularly useful in connection with the channel multiplication techniques of the cited and incorporated applications in that the recovered channels not only have useful interchannel amplitude relationships but also have useful interchannel phase relationships. Another alternative is to employ a matrix decoder to derive additional channels. See, for example, the examples of FIGS. 10, 11 and 12, below and their descriptions. The interchannel amplitude- and phase-preservation aspects of the present invention make the output channels of a decoder embodying aspects of the present invention particularly suitable for application to an amplitude- and phase-sensitive matrix decoder. For example, if the aspects of the present invention are embodied in an N:1:N system in which N is 2, the two channels recovered by the decoder may be applied to a 2:M matrix decoder. Many suitable matrix decoders are well known in the art, including, for example, matrix decoders known as “Pro Logic” and “Pro Logic II” decoders (“Pro Logic” is a trademark of Dolby Laboratories Licensing Corporation) and matrix decoders embodying aspects of the subject matter disclosed in one or more of the following U.S. Patents and published International Applications (each designating the United States), each of which is hereby incorporated by reference in its entirety: U.S. Pat. Nos. 4,799,260; 4,941,177; 5,046,098; 5,274,740; 5,400,433; 5,625,696; 5,644,640; 5,504,819; 5,428,687; 5,172,415; WO 01/41504; WO 01/41505; and WO 02/19768.

Referring again to FIG. 2, the received mono composite audio channel is applied to a plurality of signal paths from which a respective one of each of the recovered multiple audio channels is derived. Each channel-deriving path includes, in either order, an amplitude adjusting function or device (“adjust amplitude”) and an angle rotation function or device (“rotate angle”). The Adjust Amplitude is intended to restore the amplitude (or energy) of the received mono composite signal relative to the amplitude (or energy) of each of the other recovered channels to an amplitude (or energy) similar to the original amplitude (or energy) of the channel relative to the other channels at the input of the encoder. The Rotate Angle is intended, for certain signal conditions, to restore the angle of the received mono composite signal relative to the angle of each of the other recovered channels to an angle similar to the original angle of the channel relative to the other channels at the input of the encoder. Preferably, under certain signal conditions, a controllable amount of pseudo-random angle variations is also imposed on the angle of a recovered channel in order to improve its decorrelation with respect to other ones of the recovered channels. Conceptually, the adjust amplitude and rotate angle functions for a particular channel scale the mono composite audio DFT coefficients to yield transform bin values for the channel.

The Adjust Amplitude for each channel may be controlled by the recovered sidechain Amplitude Scale Factor for the particular channel or, in the case of the reference channel, either from the recovered sidechain Amplitude Scale Factor for the reference channel or from an Amplitude Scale Factor deduced from the recovered sidechain Amplitude Scale Factors of the other, non-reference, channels. The Rotate Angle for each channel may be controlled at least by the recovered sidechain Angle Control Parameter (in which case, the rotate angle in the decoder substantially undoes the angle rotation provided by the rotate angle in the encoder). To enhance decorrelation of the recovered channels, a Rotate Angle may also be controlled by a Pseudo-Random Angle Control Parameter derived from the recovered sidechain Decorrelation Scale Factor for a particular channel and the recovered sidechain Transient Flag for the particular channel. The Pseudo-Random Angle Control Parameter for a channel may be derived from the recovered Decorrelation Scale Factor for the channel and the recovered Transient Flag for the channel by a controllable decorrelator function or device (“Controllable Decorrelator”).

Referring to the example of FIG. 2, the recovered mono composite audio is applied to a first channel audio recovery path 22, which derives the channel 1 audio, and to a second channel audio recovery path 24, which derives the channel n audio. Audio path 22 includes an adjust amplitude 26, a rotate angle 28, and, if a PCM output is desired, an inverse filterbank 30. Similarly, audio path 24 includes an adjust amplitude 32, a rotate angle 34, and, if a PCM output is desired, an inverse filterbank 36. As with the case of FIG. 1, only two channels are shown for simplicity in presentation, it being understood that there may be more than two channels.

The recovered sidechain information for the first channel, channel 1, may include an Amplitude Scale Factor, an Angle Control Parameter, a Decorrelation Scale Factor, and a Transient Flag, as stated above in connection with the description of a basic encoder. The Amplitude Scale Factor is applied to adjust amplitude 26. The Transient Flag and Decorrelation Scale Factor are applied to a controllable decorrelator 38 that generates a Pseudo-Random Angle Control Parameter in response thereto. The Angle Control Parameter and the Pseudo-Random Angle Control Parameter are summed together by an additive combiner or combining function 40 in order to provide a control signal for Rotate Angle 28.

Similarly, recovered sidechain information for the second channel, channel n, may also include an Amplitude Scale Factor, an Angle Control Parameter, a Decorrelation Scale Factor, and a Transient Flag, as described above in connection with the description of a basic encoder. The Amplitude Scale Factor is applied to Adjust Amplitude 32. The Transient Flag and Decorrelation Scale Factor are applied to a controllable decorrelator or decorrelator function (“Controllable Decorrelator”) 42 that generates a Pseudo-Random Angle Control Parameter in response thereto. The Angle Control Parameter and the Pseudo-Random Angle Control Parameter are summed together by an additive combiner or combining function 44 in order to provide a control signal for Rotate Angle 34.

Although a process or topology as just described is useful for understanding, essentially the same results may be obtained with alternative processes or topologies that achieve the same or similar results. For example, the order of Adjust Amplitude 26 (32) and Rotate Angle 28 (34) may be reversed and/or there may be more than one Rotate Angle—one that responds to the Angle Control Parameter and another that responds to the Pseudo-Random Angle Control Parameter. The Rotate Angle may also be considered to be three rather than one or two functions or devices, as in the example described below.

If a reference channel is employed, as discussed above in connection with the basic encoder, the Rotate Angle, Controllable Decorrelator and Additive Combiner for that channel may be omitted inasmuch as the sidechain information for the reference channel may include only the Amplitude Scale Factor (or, alternatively, if the sidechain information does not contain an Amplitude Scale Factor for the reference channel, it may be deduced from Amplitude Scale Factors of the other channels when the energy normalization in the encoder assures that the scale factors across channels within a subband sum square to 1). An Amplitude Adjust is provided for the reference channel and it is controlled by a received or derived Amplitude Scale Factor for the reference channel. Whether the reference channel's Amplitude Scale Factor is derived from the sidechain or is deduced in the decoder, the recovered reference channel is an amplitude-scaled version of the mono composite channel. It does not require angle rotation because it is the reference for the other channels' rotations.

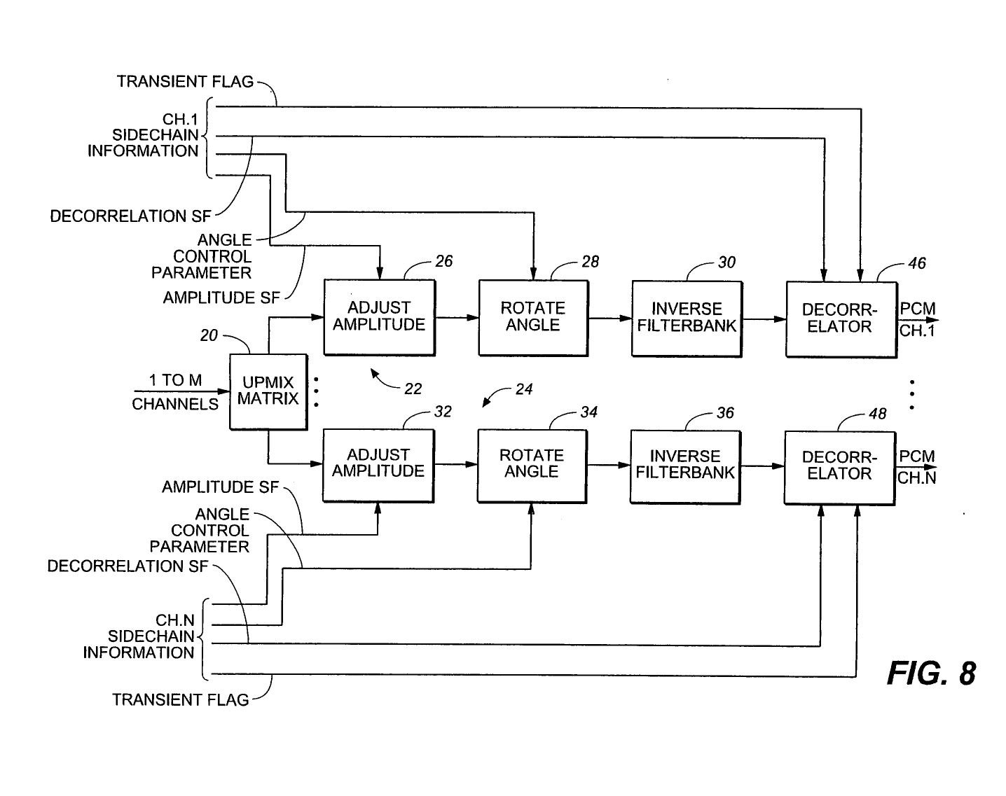

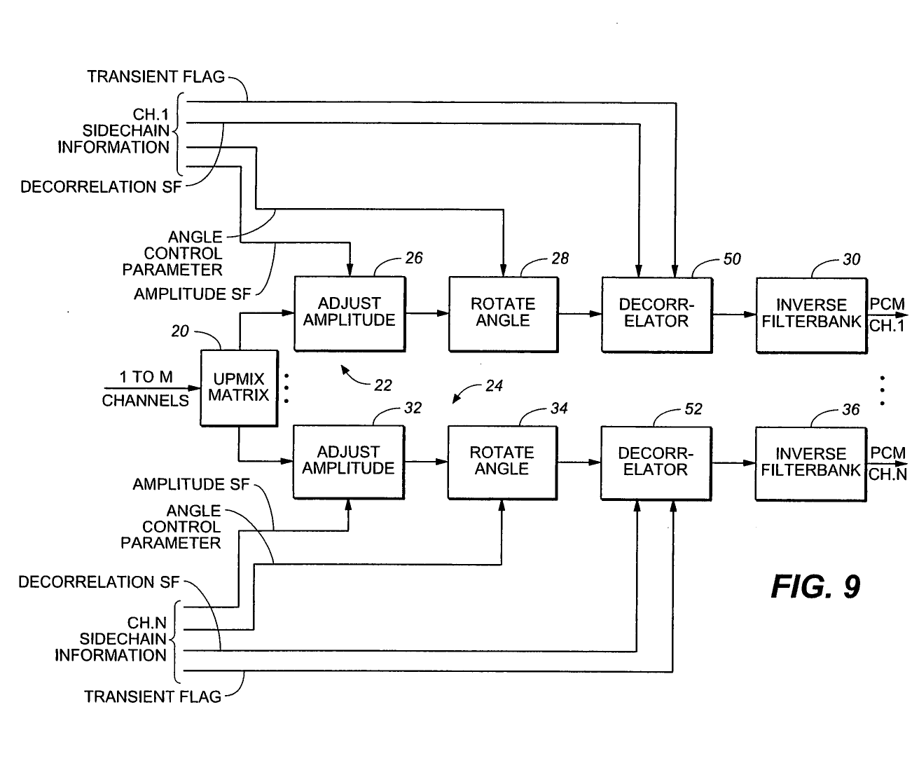

Although adjusting the relative amplitude of recovered channels may provide a modest degree of decorrelation, if used alone amplitude adjustment is likely to result in a reproduced soundfield substantially lacking in spatialization or imaging for many signal conditions (e.g., a “collapsed” soundfield). Amplitude adjustment may affect interaural level differences at the ear, which is only one of the psychoacoustic directional cues employed by the ear. Thus, according to aspects of the invention, certain angle-adjusting techniques may be employed, depending on signal conditions, to provide additional decorrelation. Reference may be made to Table 1 that provides abbreviated comments useful in understanding angle-adjusting decorrelation techniques that may be employed in accordance with aspects of the invention. Other decorrelation techniques as described below in connection with the examples of FIGS. 8 and 9 may be employed instead of or in addition to the techniques of Table 1.

TABLE 1
Angle-Adjusting Decorrelation Techniques

| | Technique 1 | Technique 2 | Technique 3 |
|---|---|---|---|
| Type of Signal | Spectrally static | Complex continuous | Complex impulsive |
| (typical example) | source | signals | signals (transients) |
| Effect on | Decorrelates low | Decorrelates non- | Decorrelates |
| Decorrelation | frequency and | impulsive complex | impulsive high |
| | steady-state signal | signal components | frequency signal |
| | components | | components |
| Effect of transient | Operates with | Does not operate | Operates |
| present in frame | shortened time | | |
| | constant | | |
| What is done | Slowly shifts | Adds to the angle | Adds to the angle |
| | (frame-by-frame) | shift of Technique 1 | shift of Technique 1 |
| | bin angle in a | a pseudo-random | a rapidly-changing |
| | channel | angle shift on a bin- | (block by block) |
| | | by-bin basis in a | pseudo-random |
| | | channel | angle shift on a |
| | | | subband-by-subband |
| | | | basis in a channel |
| Controlled by or | Degree of basic shift | Degree of additional | Degree of additional |
| Scaled by | is controlled by | shift is scaled | shift is scaled |
| | Angle Control | directly by | indirectly by |
| | Parameter | Decorrelation SF; | Decorrelation SF; |
| | | same scaling across | same scaling across |
| | | subband, scaling | subband, scaling |
| | | updated every frame | updated every frame |
| Frequency | Subband (same or | Bin (different | Subband (same |
| Resolution of angle | interpolated shift | pseudo-random shift | pseudo-random shift |
| shift | value applied to all | value applied to | value applied to all |
| | bins in each | each bin) | bins in each |
| | subband) | | subband; different |
| | | | pseudo-random shift |
| | | | value applied to |
| | | | each subband in |
| | | | channel) |
| Time Resolution | Frame (shift values | Pseudo-random shift | Block (pseudo- |
| | updated every | values remain the | random shift values |
| | frame) | same and do not | updated every |
| | | change | block) |

For signals that are substantially static spectrally, such as, for example, a pitch pipe note, a first technique (“Technique 1”) restores the angle of the received mono composite signal relative to the angle of each of the other recovered channels to an angle similar (subject to frequency and time granularity and to quantization) to the original angle of the channel relative to the other channels at the input of the encoder. Phase angle differences are useful, particularly, for providing decorrelation of low-frequency signal components below about 1500 Hz where the ear follows individual cycles of the audio signal. Preferably, Technique 1 operates under all signal conditions to provide a basic angle shift.

For high-frequency signal components above about 1500 Hz, the ear does not follow individual cycles of sound but instead responds to waveform envelopes (on a critical band basis). Hence, above about 1500 Hz decorrelation is better provided by differences in signal envelopes rather than phase angle differences. Applying phase angle shifts only in accordance with Technique 1 does not alter the envelopes of signals sufficiently to decorrelate high frequency signals. The second and third techniques (“Technique 2” and “Technique 3”, respectively) add a controllable amount of pseudo-random angle variations to the angle determined by Technique 1 under certain signal conditions, thereby causing a controllable amount of pseudo-random envelope variations, which enhances decorrelation. Preferably, a controllable degree of Technique 2 or Technique 3 operates along with Technique 1 under certain signal conditions.

Technique 2 is suitable for complex continuous signals that are rich in harmonics, such as massed orchestral violins. Technique 3 is suitable for complex impulsive or transient signals, such as applause, castanets, etc. (Technique 2 time smears claps in applause, making it unsuitable for such signals). As explained further below, in order to minimize audible artifacts, Technique 2 and Technique 3 have different time and frequency resolutions for applying pseudo-random angle variations—Technique 2 is selected when a transient is not present, whereas Technique 3 is selected when a transient is present.

Technique 1 slowly shifts (frame by frame) the bin angle in a channel. The degree of this basic shift is controlled by the Angle Control Parameter (no shift if the parameter is zero). As explained further below, either the same or an interpolated parameter is applied to all bins in each subband and the parameter is updated every frame. Consequently, each subband of each channel may have a phase shift with respect to other channels, providing a degree of decorrelation at low frequencies (below about 1500 Hz). However, Technique 1, by itself, is unsuitable for a transient signal such as applause. For such signal conditions, the reproduced channels may exhibit an annoying unstable comb-filter effect. In the case of applause, essentially no decorrelation is provided by adjusting the relative amplitude of recovered channels because all channels tend to have the same amplitude over the period of a frame.

Technique 2 operates when a transient is not present. Technique 2 adds to the angle shift of Technique 1 a pseudo-random angle shift that does not change with time, on a bin-by-bin basis (each bin has a different pseudo-random shift) in a channel, causing the envelopes of the channels to be different from one another, thus providing decorrelation of complex signals among the channels. Maintaining the pseudo-random phase angle values constant over time avoids block or frame artifacts that may result from block-to-block or frame-to-frame alteration of bin phase angles. While this technique is a very useful decorrelation tool when a transient is not present, it may temporally smear a transient (resulting in what is often referred to as “pre-noise”—the post-transient smearing is masked by the transient). The degree of additional shift provided by Technique 2 is scaled directly by the Decorrelation Scale Factor (there is no additional shift if the scale factor is zero). Ideally, the amount of pseudo-random phase angle added to the base angle shift (of Technique 1) according to Technique 2 is controlled by the Decorrelation Scale Factor in a manner that avoids audible signal warbling artifacts. Although a different additional pseudo-random angle shift value is applied to each bin and that shift value does not change, the same scaling is applied across a subband and the scaling is updated every frame.

Technique 3 operates in the presence of a transient. It shifts all the bins in each subband in a channel from block to block with a unique pseudo-random angle value, common to all bins in the subband, causing not only the envelopes, but also the amplitudes and phases, of the signals in a channel to change with respect to other channels from block to block. This reduces steady-state signal similarities among the channels and provides decorrelation of the channels substantially without causing “pre-noise” artifacts. Although the ear does not respond to pure angle changes directly at high frequencies, when two or more channels mix acoustically on their way from loudspeakers to a listener, phase differences may cause amplitude changes (comb-filter effects) that may be audible and objectionable, and these are broken up by Technique 3. The impulsive characteristics of the signal minimize block-rate artifacts that might otherwise occur. Thus, Technique 3 adds to the phase shift of Technique 1 a rapidly changing (block by block) pseudo-random angle shift on a subband-by-subband basis in a channel. The degree of additional shift is scaled indirectly, as described below, by the Decorrelation Scale Factor (there is no additional shift if the scale factor is zero). The same scaling is applied across a subband and the scaling is updated every frame.

Although the angle-adjusting techniques have been characterized as three techniques, this is a matter of semantics and they may also be characterized as two techniques: (1) a combination of Technique 1 and a variable degree of Technique 2, which may be zero, and (2) a combination of Technique 1 and a variable degree Technique 3, which may be zero. For convenience in presentation, the techniques are treated as being three techniques.

Sidechain Information

As mentioned above, the sidechain information may include: an Amplitude Scale Factor, an Angle Control Parameter, a Decorrelation Scale Factor, and a Transient Flag. Such sidechain information for a practical embodiment of aspects of the present invention may be summarized in the following Table 2. Typically, the sidechain information may be updated once per frame.

TABLE 2
Sidechain Information Characteristics for a Channel

| Sidechain | | Represents | Quantization | Primary |
|---|---|---|---|---|
| Parameter | Value Range | (is “a measure of”) | Levels | Purpose |
| Subband Angle | 0 [symbol] + 2π | Smoothed time | 6 bit (64 levels) | Provides |
| Control | | average across | | basic angle |
| Parameter | | subband of | | rotation for |
| | | difference | | each bin in |
| | | between angle of | | channel |
| | | each bin in | | |
| | | subband for a | | |
| | | channel and that | | |
| | | of the | | |
| | | corresponding bin | | |
| | | of a reference | | |
| | | channel | | |
| Subband | 0 [symbol] 1 | Spectral- | 3 bit (8 levels) | Scales |
| Decorrelation | The Subband | steadiness of | | pseudo- |
| Scale Factor | Decorrelation | signal | | random |
| | Scale Factor is | characteristics | | angle shifts |
| | high only if | over time in a | | added to |
| | both the | subband of a | | basic angle |
| | Spectral- | channel (the | | rotation |
| | Steadiness | Spectral- | | |
| | Factor and the | Steadiness Factor) | | |
| | Interchannel | and the | | |
| | Angle | consistency in the | | |
| | Consistency | same subband of a | | |
| | Factor are low. | channel of bin | | |
| | | angles with | | |
| | | respect to | | |
| | | corresponding | | |
| | | bins of a reference | | |
| | | channel (the | | |
| | | Interchannel | | |
| | | Angle Consistency | | |
| | | Factor) | | |
| Subband | 0 to 31 (whole | Energy or | 5 bit (32 levels) | Scales |
| Amplitude Scale | integer) | amplitude in | Granularity is 1.5 | amplitude |
| Factor | 0 is highest | subband of a | dB, so the range | of bins in a |
| | amplitude | channel with | is 31*1.5 = 46.5 | subband in |
| | 31 is lowest | respect to energy | dB plus final | a channel |
| | amplitude | or amplitude for | value = off. | |
| | | same subband | | |
| | | across all channels | | |
| Transient Flag | 1, 0 | Presence of a | 1 bit (2 levels) | Determines |
| | (True/False) | transient in the | | which |
| | (polarity is | frame | | technique |
| | arbitrary) | | | for adding |
| | | | | pseudo- |
| | | | | random |
| | | | | angle shifts |
| | | | | is employed |

In each case, the sidechain information of a channel applies to a single subband (except for the Transient Flag, which applies to all subbands) and may be updated once per frame. Although the time resolution (once per frame), frequency resolution (subband), value ranges and quantization levels indicated have been found to provide useful performance and a useful compromise between a low bit rate and performance, it will be appreciated that these time and frequency resolutions, value ranges and quantization levels are not critical and that other resolutions, ranges and levels may employed in practicing aspects of the invention.

It will be noted that Technique 2, described above (see also Table 1), provides a bin frequency resolution rather than a subband frequency resolution (i.e., a different pseudo random phase angle shift is applied to each bin rather than to each subband) even though the same Subband Decorrelation Scale Factor applies to all bins in a subband. It will also be noted that Technique 3, described above (see also Table 1), provides a block frequency resolution (i.e., a different pseudo-random phase angle shift is applied to each block rather than to each frame) even though the same Subband Decorrelation Scale Factor applies to all bins in a subband. Such resolutions, greater than the resolution of the sidechain information, are possible because the pseudo-random phase angle shifts may be generated in a decoder and need not be known in the encoder (this is the case even if the encoder also applies a pseudo-random phase angle shift to the encoded mono composite signal, an alternative that is described below). In other words, it is not necessary to send sidechain information having bin or block granularity even though the decorrelation techniques employ such granularity. The decoder may employ, for example, one or more lookup tables of pseudo-randomly-chosen bin phase angles. The obtaining of time and/or frequency resolutions for decorrelation greater than the sidechain information rates is among the aspects of the present invention. Thus, decorrelation by way of randomized phases is performed either with a fine frequency resolution (bin-by-bin) that does not change with time (Technique 2), or with a coarse frequency resolution (band-by-band and a fine time resolution (block rate) (Technique 3).

It will also be appreciated that as increasing degrees of pseudo-random phase shifts are added to the phase angle of a recovered channel, that the absolute phase angle of the recovered channel differs more and more from the original absolute phase angle of that channel. An aspect of the present invention is the appreciation that the resulting absolute phase angle of the recovered channel need not match that of the original channel when signal conditions are such that the pseudo-random phase shifts are added in accordance with aspects of the present invention. For example, in extreme cases when the Decorrelation Scale Factor causes the highest degree of pseudo-random phase shift, the phase shift caused by Technique 2 or Technique 3 overwhelms the basic phase shift caused by Technique 1. Nevertheless, this is of no concern in that a pseudo-random phase shift is audibly the same as the different random phases in the original signal that give rise to a Decorrelation Scale Factor that causes the addition of some degree of pseudo-random phase shifts.

Inasmuch as the Transient Flag applies to a frame, the time resolution with which the Transient Flag selects Technique 2 or Technique 3 may be enhanced by providing a supplemental transient detector in the decoder in order to provide a resolution finer than the frame rate or even the block rate. Such a supplemental transient detector may detect the occurrence of a transient in the mono composite audio signal received by the decoder and such detection information is then sent to each controllable decorrelator (as 38, 42 of FIG. 2). Then, upon the receipt of a Transient Flag for its channel, the controllable decorrelator switches from Technique 2 to Technique 3 upon receipt of the decoder's local transient detection indication. Thus, a substantial improvement in resolution is possible without increasing the sidechain bit rate.

As an alternative to sending sidechain information on a frame-by-frame basis, sidechain information may be updated every block, at least for highly dynamic signals. In order to accomplish that without substantially increasing the sidechain data rate, a block-floating-point differential coding arrangement may be used. For example, consecutive transform blocks may be collected in groups of six over a frame. The full sidechain information may be sent for each subband-channel in the first block. In the five subsequent blocks, only differential values may be sent, each the difference between the current-block amplitude and angle, and the equivalent values from the previous-block. This results in very low data rate for static signals, such as a pitch pipe note. For more dynamic signals, a greater range of difference values is required, but at less precision. So, for each group of five differential values, an exponent may be sent first, using, for example, 3 bits, then differential values are quantized to, for example, 2-bit accuracy. This arrangement reduces the average worst-case side chain data rate by about a factor of two. Further reduction may be obtained by omitting the side chain data for a reference channel (since it can be derived from the other channels), as discussed above, and by using, for example, arithmetic coding. Alternatively or in addition, differential coding across frequency may be employed by sending, for example, differences in subband angle or amplitude.

Whether sidechain information is sent on a frame-by-frame basis or more frequently, it may be useful to interpolate sidechain values across the blocks in a frame. Linear interpolation over time may be employed in the manner of the linear interpolation across frequency, as described below.

One suitable implementation of aspects of the present invention employs processing steps or devices that implement the respective processing steps and are functionally related as next set forth. Although the encoding and decoding steps listed below may each be carried out by computer software instruction sequences operating in the order of the below listed steps, it will be understood that equivalent or similar results may be obtained by steps ordered in other ways, taking into account that certain quantities are derived from earlier ones. For example, multi-threaded computer software instruction sequences may be employed so that certain sequences of steps are carried out in parallel. Alternatively, the described steps may be implemented as devices that perform the described functions, the various devices having functional interrelationships as described hereinafter.

Encoding

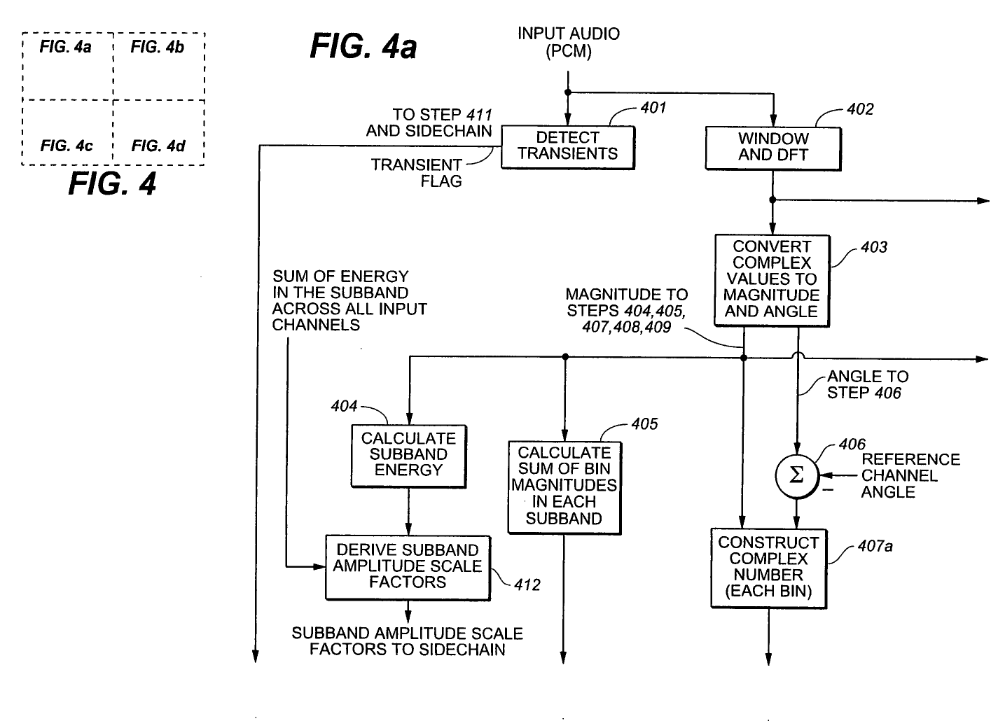

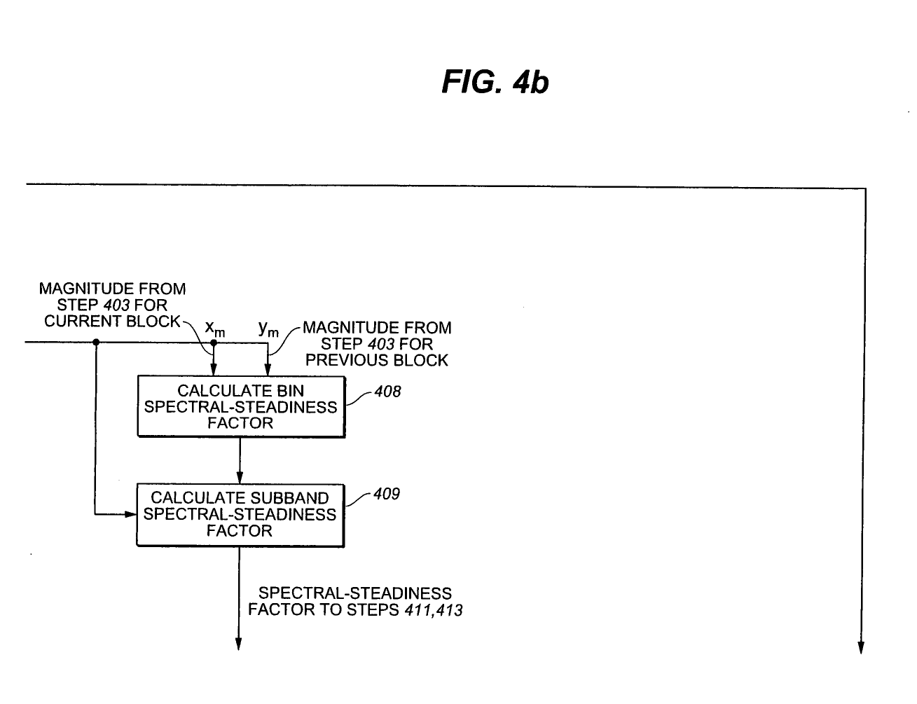

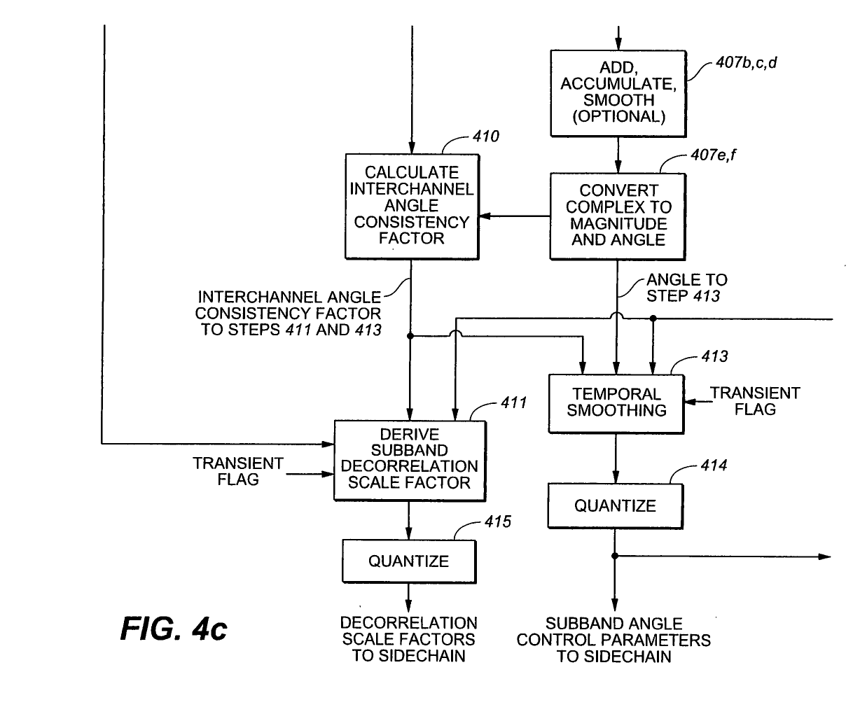

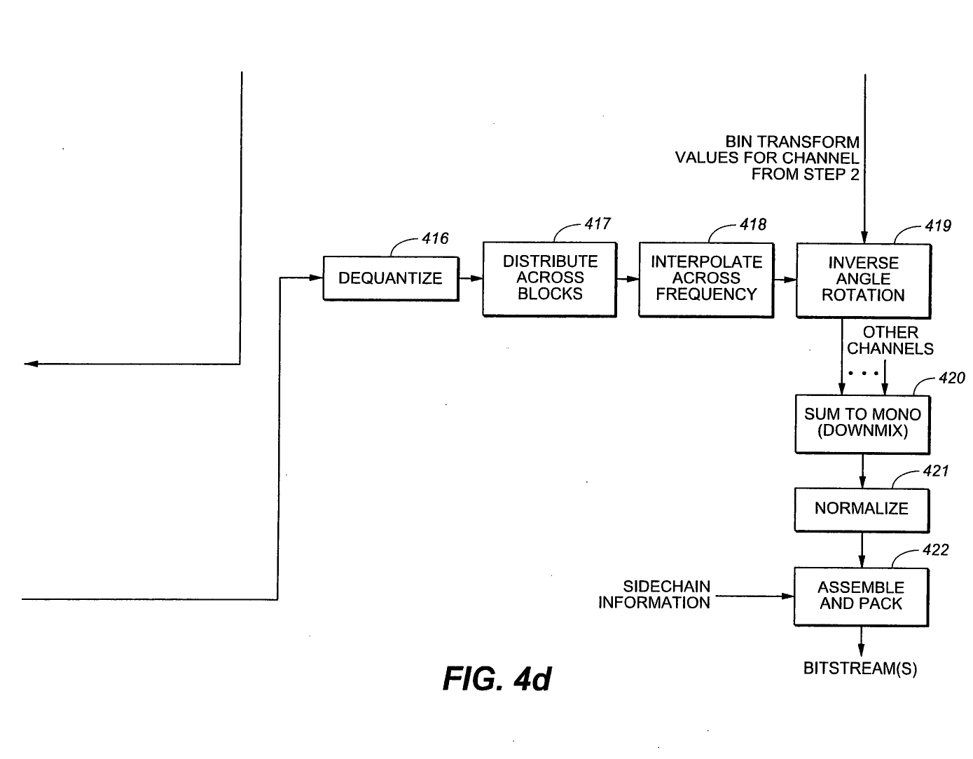

The encoder or encoding function may collect a frame's worth of data before it derives sidechain information and downmixes the frame's audio channels to a single monophonic (mono) audio channel. By doing so, sidechain information may be sent first to a decoder, allowing the decoder to begin decoding immediately upon receipt of the mono audio channel information. Steps of an encoding process (“encoding steps”) may be described as follows. With respect to encoding steps, reference is made to FIG. 4, which is in the nature of a hybrid flowchart and functional block diagram. Through Step 419, FIG. 4 shows encoding steps for one channel. Steps 420 and 421 apply to all of the multiple channels that are combined to provide a composite mono signal output.

Step 401. Detect Transients

a. Perform transient detection of the PCM values in an input audio channel.

b. Set a one-bit Transient Flag True if a transient is present in any block of a frame for the channel.

Comments regarding Step 401:

The Transient Flag forms a portion of the sidechain information and is also used in Step 411, as described below. Although a block-rate rather than a frame-rate Transient Flag may form a portion of the sidechain information with a modest increase in bit rate, increasing transient information resolution to a block rate is not believed to noticeably improve decoder performance. However, as mentioned above, transient resolution finer than block rate in the decoder may improve decoder performance and this may be accomplished without increasing the sidechain bit rate by detecting the occurrence of transients in the mono composite signal received in the decoder.

There is one transient flag per channel per frame, which, because it is derived in the time domain, necessarily applies to all subbands within that channel. The transient detection may be performed in the manner similar to that employed in an AC-3 encoder for controlling the decision of when to switch between long and short length audio blocks, but with a higher sensitivity and with the Transient Flag True for any frame in which the Transient Flag for a block is True (the AC-3 encoder detects transients on a block basis). In particular, see Section 8.2.2 of the above-cited A/52A document. The sensitivity of the transient detection described in Section 8.2.2 may be increased by adding a sensitivity factor F to an equation set forth therein. Section 8.2.2 of the A/52A document is set forth below, with the sensitivity factor added (Section 8.2.2 as reproduced below is corrected to indicate that the low pass filter is a cascaded biquad direct form II IIR filter rather than “form I” as in the published A/52A document; Section 8.2.2 was correct in the earlier A/52 document). Although it is not critical, a sensitivity factor of 0.2 has been found to be a suitable value in a practical embodiment of aspects of the present invention.

Alternatively, a similar transient detection technique described in U.S. Pat. No. 5,394,473 may be employed. The '473 patent describes aspects of the A/52A document transient detector in greater detail. Both said A/52A document and said '473 patent are hereby incorporated by reference in their entirety.

As another alternative, transients may be detected in the frequency domain rather than in the time domain. In that case, Step 401 may be omitted and an alternative step employed in the frequency-domain as described below.

Step 402. Window and DFT.

Window PCM values and convert them to complex frequency values via a DFT as implemented by an FFT.

Step 403. Convert Complex Values to Magnitude and Angle.

Convert each frequency-domain complex transform bin value (a+jb) to a magnitude and angle representation using standard complex manipulations:
a. Magnitude=square_root (a²+b²)
b. Angle=arctan (b/a)

Comments regarding Step 403:

Some of the following Steps use or may use, as an alternative, the energy of a bin, defined as the above magnitude squared (i.e., energy=(a²+b²).

Step 404. Calculate Subband Energy.

a. Calculate the subband energy per block by adding bin energy values within each subband (a summation across frequency).

b. Calculate the subband energy per frame by averaging or accumulating the energy in all the blocks in a frame (an averaging/accumulation across time).

c. If the coupling frequency of the encoder is below about 1000 Hz, apply the subband frame-averaged or frame-accumulated energy to a time smoother that operates on all subbands below that frequency and above the coupling frequency.

Comments regarding Step 404c:

Time smoothing to provide inter-frame smoothing in low frequency subbands may be useful. In order to avoid artifact-causing discontinuities between bin values at subband boundaries, it may be useful to apply a progressively-decreasing time smoothing from the lowest frequency subband encompassing and above the coupling frequency (where the smoothing may have a significant effect) up through a higher frequency subband in which the time smoothing effect is measurable, but inaudible, although nearly audible. A suitable time constant for the lowest frequency range subband (where the subband is a single bin if subbands are critical bands) may be in the range of 50 to 100 milliseconds, for example. Progressively-decreasing time smoothing may continue up through a subband encompassing about 1000 Hz where the time constant may be about 10 milliseconds, for example.

Although a first-order smoother is suitable, the smoother may be a two-stage smoother that has a variable time constant that shortens its attack and decay time in response to a transient (such a two-stage smoother may be a digital equivalent of the analog two-stage smoothers described in U.S. Pat. Nos. 3,846,719 and 4,922,535, each of which is hereby incorporated by reference in its entirety). In other words, the steady-state time constant may be scaled according to frequency and may also be variable in response to transients. Alternatively, such smoothing may be applied in Step 412.

Step 405. Calculate Sum of Bin Magnitudes.

a. Calculate the sum per block of the bin magnitudes (Step 403) of each subband (a summation across frequency).

b. Calculate the sum per frame of the bin magnitudes of each subband by averaging or accumulating the magnitudes of Step 405a across the blocks in a frame (an averaging/accumulation across time). These sums are used to calculate an Interchannel Angle Consistency Factor in Step 410 below.

c. If the coupling frequency of the encoder is below about 1000 Hz, apply the subband frame-averaged or frame-accumulated magnitudes to a time smoother that operates on all subbands below that frequency and above the coupling frequency.

Comments regarding Step 405c: See comments regarding step 404c except that in the case of Step 405c, the time smoothing may alternatively be performed as part of Step 410.

Step 406. Calculate Relative Interchannel Bin Phase Angle.

Calculate the relative interchannel phase angle of each transform bin of each block by subtracting from the bin angle of Step 403 the corresponding bin angle of a reference channel (for example, the first channel). The result, as with other angle additions or subtractions herein, is taken modulo (π, −π) radians by adding or subtracting 2π until the result is within the desired range of −π to +π.

Step 407). Calculate Interchannel Subband Phase Angle.

For each channel, calculate a frame-rate amplitude-weighted average interchannel phase angle for each subband as follows:
a. For each bin, construct a complex number from the magnitude of Step 403 and the relative interchannel bin phase angle of Step 406.
b. Add the constructed complex numbers of Step 407a across each subband (a summation across frequency).
Comment regarding Step 407b: For example, if a subband has two bins and one of the bins has a complex value of 1+j1 and the other bin has a complex value of 2+j2, their complex sum is 3+j3.
c. Average or accumulate the per block complex number sum for each subband of Step 407b across the blocks of each frame (an averaging or accumulation across time).
d. If the coupling frequency of the encoder is below about 1000 Hz, apply the subband frame-averaged or frame-accumulated complex value to a time smoother that operates on all subbands below that frequency and above the coupling frequency.
Comments regarding Step 407d: See comments regarding Step 404c except that in the case of Step 407d, the time smoothing may alternatively be performed as part of Steps 407e or 410.
e. Compute the magnitude of the complex result of Step 407d as per Step 403.
Comment regarding Step 407e: This magnitude is used in Step 410a below. In the simple example given in Step 407b, the magnitude of 3+j3 is square_root (9+9)=4.24.
f. Compute the angle of the complex result as per Step 403.
Comments regarding Step 407f: In the simple example given in Step 407b, the angle of 3+j3 is arctan (3/3)=45 degrees=π/4 radians. This subband angle is signal-dependently time-smoothed (see Step 413) and quantized (see Step 414) to generate the Subband Angle Control Parameter sidechain information, as described below.

Step 408. Calculate Bin Spectral-Steadiness Factor

For each bin, calculate a Bin Spectral-Steadiness Factor in the range of 0 to 1 as follows:
a. Let xₘ=bin magnitude of present block calculated in Step 403.
b. Let yₘ=corresponding bin magnitude of previous block.
c. If xₘ>yₘ, then Bin Dynamic Amplitude Factor=(yₘ/xₘ)²;
d. Else if yₘ>x_{m,} then Bin Dynamic Amplitude Factor=(xₘ/yₘ)²,
e. Else if yₘ=xₘ, then Bin Spectral-Steadiness Factor=1.

Comment regarding Step 408:

“Spectral steadiness” is a measure of the extent to which spectral components (e.g., spectral coefficients or bin values) change over time. A Bin Spectral-Steadiness Factor of 1 indicates no change over a given time period.

Alternatively, Step 408 may look at three consecutive blocks. If the coupling frequency of the encoder is below about 1000 Hz, Step 408 may look at more than three consecutive blocks. The number of consecutive blocks may taken into consideration vary with frequency such that the number gradually increases as the subband frequency range decreases.

As a further alternative, bin energies may be used instead of bin magnitudes.

As yet a further alternative, Step 408 may employ an “event decision” detecting technique as described below in the comments following Step 409.

Step 409. Compute Subband Spectral-Steadiness Factor.

Compute a frame-rate Subband Spectral-Steadiness Factor on a scale of 0 to 1 by forming an amplitude-weighted average of the Bin Spectral-Steadiness Factor within each subband across the blocks in a frame as follows:
a. For each bin, calculate the product of the Bin Spectral-Steadiness Factor of Step 408 and the bin magnitude of Step 403.
b. Sum the products within each subband (a summation across frequency).
c. Average or accumulate the summation of Step 409b in all the blocks in a frame (an averaging/accumulation across time).
d. If the coupling frequency of the encoder is below about 1000 Hz, apply the subband frame-averaged or frame-accumulated summation to a time smoother that operates on all subbands below that frequency and above the coupling frequency.
Comments regarding Step 409d: See comments regarding Step 404c except that in the case of Step 409d, there is no suitable subsequent step in which the time smoothing may alternatively be performed.
e. Divide the results of Step 409c or Step 409d, as appropriate, by the sum of the bin magnitudes (Step 403) within the subband.
Comment regarding Step 409e: The multiplication by the magnitude in Step 409a and the division by the sum of the magnitudes in Step 409e provide amplitude weighting. The output of Step 408 is independent of absolute amplitude and, if not amplitude weighted, may cause the output or Step 409 to be controlled by very small amplitudes, which is undesirable.
f. Scale the result to obtain the Subband Spectral-Steadiness Factor by mapping the range from {0.5 . . . 1} to {0 . . . 1}. This may be done by multiplying the result by 2, subtracting 1, and limiting results less than 0 to a value of 0.
Comment regarding Step 409f: Step 409f may be useful in assuring that a channel of noise results in a Subband Spectral-Steadiness Factor of zero.

Comments regarding Steps 408 and 409:

The goal of Steps 408 and 409 is to measure spectral steadiness—changes in spectral composition over time in a subband of a channel. Alternatively, aspects of an “event decision” sensing such as described in International Publication Number WO 02/097792 A1 (designating the United States) may be employed to measure spectral steadiness instead of the approach just described in connection with Steps 408 and 409. U.S. patent application Ser. No. 10/478,538, filed Nov. 20, 2003 is the United States' national application of the published PCT Application WO 02/097792 A1. Both the published PCT application and the U.S. application are hereby incorporated by reference in their entirety. According to these incorporated applications, the magnitudes of the complex FFT coefficient of each bin are calculated and normalized (largest magnitude is set to a value of one, for example). Then the magnitudes of corresponding bins (in dB) in consecutive blocks are subtracted (ignoring signs), the differences between bins are summed, and, if the sum exceeds a threshold, the block boundary is considered to be an auditory event boundary. Alternatively, changes in amplitude from block to block may also be considered along with spectral magnitude changes (by looking at the amount of normalization required).

If aspects of the incorporated event-sensing applications are employed to measure spectral steadiness, normalization may not be required and the changes in spectral magnitude (changes in amplitude would not be measured if normalization is omitted) preferably are considered on a subband basis. Instead of performing Step 408 as indicated above, the decibel differences in spectral magnitude between corresponding bins in each subband may be summed in accordance with the teachings of said applications. Then, each of those sums, representing the degree of spectral change from block to block may be scaled so that the result is a spectral steadiness factor having a range from 0 to 1, wherein a value of 1 indicates the highest steadiness, a change of 0 dB from block to block for a given bin. A value of 0, indicating the lowest steadiness, may be assigned to decibel changes equal to or greater than a suitable amount, such as 12 dB, for example. These results, a Bin Spectral-Steadiness Factor, may be used by Step 409 in the same manner that Step 409 uses the results of Step 408 as described above. When Step 409 receives a Bin Spectral-Steadiness Factor obtained by employing the just-described alternative event decision sensing technique, the Subband Spectral-Steadiness Factor of Step 409 may also be used as an indicator of a transient. For example, if the range of values produced by Step 409 is 0 to 1, a transient may be considered to be present when the Subband Spectral-Steadiness Factor is a small value, such as, for example, 0.1, indicating substantial spectral unsteadiness.

It will be appreciated that the Bin Spectral-Steadiness Factor produced by Step 408 and by the just-described alternative to Step 408 each inherently provide a variable threshold to a certain degree in that they are based on relative changes from block to block. Optionally, it may be useful to supplement such inherency by specifically providing a shift in the threshold in response to, for example, multiple transients in a frame or a large transient among smaller transients (e.g., a loud transient coming atop mid- to low-level applause). In the case of the latter example, an event detector may initially identify each clap as an event, but a loud transient (e.g., a drum hit) may make it desirable to shift the threshold so that only the drum hit is identified as an event.

Alternatively, a randomness metric may be employed (for example, as described in U.S. Pat. Re 36,714, which is hereby incorporated by reference in its entirety) instead of a measure of spectral-steadiness over time.

Step 410. Calculate Interchannel Angle Consistency Factor.

For each subband having more than one bin, calculate a frame-rate Interchannel Angle Consistency Factor as follows:
a. Divide the magnitude of the complex sum of Step 407e by the sum of the magnitudes of Step 405. The resulting “raw” Angle Consistency Factor is a number in the range of 0 to 1.
b. Calculate a correction factor: let n=the number of values across the subband contributing to the two quantities in the above step (in other words, “n” is the number of bins in the subband). If n is less than 2, let the Angle Consistency Factor be 1 and go to Steps 411 and 413.
c. Let r=Expected Random Variation=1/n. Subtract r from the result of the Step 410b.
d. Normalize the result of Step 410c by dividing by (1−r). The result has a maximum value of 1. Limit the minimum value to 0 as necessary.

Comments regarding Step 410:

Interchannel Angle Consistency is a measure of how similar the interchannel phase angles are within a subband over a frame period. If all bin interchannel angles of the subband are the same, the Interchannel Angle Consistency Factor is 1.0; whereas, if the interchannel angles are randomly scattered, the value approaches zero.

The Subband Angle Consistency Factor indicates if there is a phantom image between the channels. If the consistency is low, then it is desirable to decorrelate the channels. A high value indicates a fused image. Image fusion is independent of other signal characteristics.

It will be noted that the Subband Angle Consistency Factor, although an angle parameter, is determined indirectly from two magnitudes. If the interchannel angles are all the same, adding the complex values and then taking the magnitude yields the same result as taking all the magnitudes and adding them, so the quotient is 1. If the interchannel angles are scattered, adding the complex values (such as adding vectors having different angles) results in at least partial cancellation, so the magnitude of the sum is less than the sum of the magnitudes, and the quotient is less than 1.

Following is a simple example of a subband having two bins:

Suppose that the two complex bin values are (3+j4) and (6+j8). (Same angle each case: angle=arctan (imag/real), so angle1=arctan (4/3) and angle2=arctan (8/6)=arctan (4/3)). Adding complex values, sum=(9+j12), magnitude of which is square_root (81+144)=15.

The sum of the magnitudes is magnitude of (3+j4)+magnitude of (6+j8)=5+10=15. The quotient is therefore 15/15=1=consistency (before 1/n normalization, would also be 1 after normalization) (Normalized consistency=(1−0.5)/(1−0.5)=1.0).

If one of the above bins has a different angle, say that the second one has complex value (6−j8), which has the same magnitude, 10. The complex sum is now (9−j4), which has magnitude of square_root (81+16)=9.85, so the quotient is 9.85/15=0.66=consistency (before normalization). To normalize, subtract 1/n=½, and divide by (1−1/n) (normalized consistency=(0.66−0.5)/(1−0.5)=0.32.)

Although the above-described technique for determining a Subband Angle Consistency Factor has been found useful, its use is not critical. Other suitable techniques may be employed. For example, one could calculate a standard deviation of angles using standard formulae. In any case, it is desirable to employ amplitude weighting to minimize the effect of small signals on the calculated consistency value.

In addition, an alternative derivation of the Subband Angle Consistency Factor may use energy (the squares of the magnitudes) instead of magnitude. This may be accomplished by squaring the magnitude from Step 403 before it is applied to Steps 405 and 407.

Step 411. Derive Subband Decorrelation Scale Factor.

Derive a frame-rate Decorrelation Scale Factor for each subband as follows:
a. Let x=frame-rate Spectral-Steadiness Factor of Step 409f.
b. Let y=frame-rate Angle Consistency Factor of Step 410e.
c. Then the frame-rate Subband Decorrelation Scale Factor=(1−x)*(1−y), a number between 0 and 1.

Comments regarding Step 411:

The Subband Decorrelation Scale Factor is a function of the spectral-steadiness of signal characteristics over time in a subband of a channel (the Spectral-Steadiness Factor) and the consistency in the same subband of a channel of bin angles with respect to corresponding bins of a reference channel (the Interchannel Angle Consistency Factor). The Subband Decorrelation Scale Factor is high only if both the Spectral-Steadiness Factor and the Interchannel Angle Consistency Factor are low.

As explained above, the Decorrelation Scale Factor controls the degree of envelope decorrelation provided in the decoder. Signals that exhibit spectral steadiness over time preferably should not be decorrelated by altering their envelopes, regardless of what is happening in other channels, as it may result in audible artifacts, namely wavering or warbling of the signal.

Step 412. Derive Subband Amplitude Scale Factors.

From the subband frame energy values of Step 404 and from the subband frame energy values of all other channels (as may be obtained by a step corresponding to Step 404 or an equivalent thereof), derive frame-rate Subband Amplitude Scale Factors as follows:
a. For each subband, sum the energy values per frame across all input channels.
b. Divide each subband energy value per frame, (from Step 404) by the sum of the energy values across all input channels (from Step 412a) to create values in the range of 0 to 1.
c. Convert each ratio to dB, in the range of to 0.
d. Divide by the scale factor granularity, which may be set at 1.5 dB, for example, change sign to yield a non-negative value, limit to a maximum value which may be, for example, 31 (i.e. 5-bit precision) and round to the nearest integer to create the quantized value. These values are the frame-rate Subband Amplitude Scale Factors and are conveyed as part of the sidechain information.
e. If the coupling frequency of the encoder is below about 1000 Hz, apply the subband frame-averaged or frame-accumulated magnitudes to a time smoother that operates on all subbands below that frequency and above the coupling frequency.

Comments regarding Step 412e: See comments regarding step 404c except that in the case of Step 412e, there is no suitable subsequent step in which the time smoothing may alternatively be performed.

Comments for Step 412:

Although the granularity (resolution) and quantization precision indicated here have been found to be useful, they are not critical and other values may provide acceptable results.

Alternatively, one may use amplitude instead of energy to generate the Subband Amplitude Scale Factors. If using amplitude, one would use dB=20*log(amplitude ratio), else if using energy, one converts to dB via dB=10*log(energy ratio), where amplitude ratio=square root (energy ratio).

Step 413. Signal-Dependently Time Smooth Interchannel Subband Phase Angles.

Apply signal-dependent temporal smoothing to subband frame-rate interchannel angles derived in Step 407f:
a. Let v=Subband Spectral-Steadiness Factor of Step 409d.
b. Let w=corresponding Angle Consistency Factor of Step 410e.
c. Let x=(1−v)*w. This is a value between 0 and 1, which is high if the Spectral-Steadiness Factor is low and the Angle Consistency Factor is high.
d. Let y=1−x. y is high if Spectral-Steadiness Factor is high and Angle Consistency Factor is low.
e. Let z=y^{exp}, where exp is a constant, which may be=0.1, z is also in the range of 0 to 1, but skewed toward 1, corresponding to a slow time constant.
f. If the Transient Flag (Step 401) for the channel is set, set z=0, corresponding to a fast time constant in the presence of a transient.
g. Compute lim, a maximum allowable value of z, lim=1−(0.1*w). This ranges from 0.9 if the Angle Consistency Factor is high to 1.0 if the Angle Consistency Factor is low (0).
h. Limit z by lim as necessary: if (z>lim) then z=lim.
i. Smooth the subband angle of Step 407f using the value of z and a running smoothed value of angle maintained for each subband. If A=angle of Step 407f and RSA=running smoothed angle value as of the previous block, and NewRSA is the new value of the running smoothed angle, then: NewRSA=RSA*z+A*(1−z). The value of RSA is subsequently set equal to NewRSA before processing the following block. New RSA is the signal-dependently time-smoothed angle output of Step 413.

Comments regarding Step 413:

When a transient is detected, the subband angle update time constant is set to 0, allowing a rapid subband angle change. This is desirable because it allows the normal angle update mechanism to use a range of relatively slow time constants, minimizing image wandering during static or quasi-static signals, yet fast-changing signals are treated with fast time constants.

Although other smoothing techniques and parameters may be usable, a first-order smoother implementing Step 413 has been found to be suitable. If implemented as a first-order smoother/lowpass filter, the variable “z” corresponds to the feed-forward coefficient (sometimes denoted “ff0”), while “(1−z)” corresponds to the feedback coefficient (sometimes denoted “fb1”).

Step 414. Quantize Smoothed Interchannel Subband Phase Angles.

Quantize the time-smoothed subband interchannel angles derived in Step 413i to obtain the Subband Angle Control Parameter:
a. If the value is less than 0, add 2π, so that all angle values to be quantized are in the range 0 to 2π.
b. Divide by the angle granularity (resolution), which may be 2π/64 radians, and round to an integer. The maximum value may be set at 63, corresponding to 6-bit quantization.

Comments regarding Step 414:

The quantized value is treated as a non-negative integer, so an easy way to quantize the angle is to map it to a non-negative floating point number ((add 2π if less than 0, making the range 0 to (less than) 2π)), scale by the granularity (resolution), and round to an integer. Similarly, dequantizing that integer (which could otherwise be done with a simple table lookup), can be accomplished by scaling by the inverse of the angle granularity factor, converting a non-negative integer to a non-negative floating point angle (again, range 0 to 2π), after which it can be renormalized to the range ±π for further use. Although such quantization of the Subband Angle Control Parameter has been found to be useful, such a quantization is not critical and other quantizations may provide acceptable results.

Step 415. Quantize Subband Decorrelation Scale Factors.

Quantize the Subband Decorrelation Scale Factors produced by Step 411 to, for example, 8 levels (3 bits) by multiplying by 7.49 and rounding to the nearest integer. These quantized values are part of the sidechain information.

Comments regarding Step 415:

Although such quantization of the Subband Decorrelation Scale Factors has been found to be useful, quantization using the example values is not critical and other quantizations may provide acceptable results.

Step 416. Dequantize Subband Angle Control Parameters.

Dequantize the Subband Angle Control Parameters (see Step 414), to use prior to downmixing.

Comment regarding Step 416:

Use of quantized values in the encoder helps maintain synchrony between the encoder and the decoder.

Step 417. Distribute Frame-Rate Dequantized Subband Angle Control Parameters Across Blocks.

In preparation for downmixing, distribute the once-per-frame dequantized Subband Angle Control Parameters of Step 416 across time to the subbands of each block within the frame.

Comment regarding Step 417:

The same frame value may be assigned to each block in the frame. Alternatively, it may be useful to interpolate the Subband Angle Control Parameter values across the blocks in a frame. Linear interpolation over time may be employed in the manner of the linear interpolation across frequency, as described below.

Step 418. Interpolate block Subband Angle Control Parameters to Bins

Distribute the block Subband Angle Control Parameters of Step 417 for each channel across frequency to bins, preferably using linear interpolation as described below.

Comment regarding Step 418:

If linear interpolation across frequency is employed, Step 418 minimizes phase angle changes from bin to bin across a subband boundary, thereby minimizing aliasing artifacts. Subband angles are calculated independently of one another, each representing an average across a subband. Thus, there may be a large change from one subband to the next. If the net angle value for a subband is applied to all bins in the subband (a “rectangular” subband distribution), the entire phase change from one subband to a neighboring subband occurs between two bins. If there is a strong signal component there, there may be severe, possibly audible, aliasing. Linear interpolation spreads the phase angle change over all the bins in the subband, minimizing the change between any pair of bins, so that, for example, the angle at the low end of a subband mates with the angle at the high end of the subband below it, while maintaining the overall average the same as the given calculated subband angle. In other words, instead of rectangular subband distributions, the subband angle distribution may be trapezoidally shaped.

For example, suppose that the lowest coupled subband has one bin and a subband angle of 20 degrees, the next subband has three bins and a subband angle of 40 degrees, and the third subband has five bins and a subband angle of 100 degrees. With no interpolation, assume that the first bin (one subband) is shifted by an angle of 20 degrees, the next three bins (another subband) are shifted by an angle of 40 degrees and the next five bins (a further subband) are shifted by an angle of 100 degrees. In that example, there is a 60-degree maximum change, from bin 4 to bin 5. With linear interpolation, the first bin still is shifted by an angle of 20 degrees, the next 3 bins are shifted by about 30, 40, and 50 degrees; and the next five bins are shifted by about 67, 83, 100, 117, and 133 degrees. The average subband angle shift is the same, but the maximum bin-to-bin change is reduced to 17 degrees.

Optionally, changes in amplitude from subband to subband, in connection with this and other steps described herein, such as Step 417 may also be treated in a similar interpolative fashion. However, it may not be necessary to do so because there tends to be more natural continuity in amplitude from one subband to the next.

Step 419. Apply Phase Angle Rotation to Bin Transform Values for Channel.

Apply phase angle rotation to each bin transform value as follows:
a. Let x=bin angle for this bin as calculated in Step 418.
b. Let y=−x;
c. Compute z, a unity-magnitude complex phase rotation scale factor with angle y, z=cos (y)+j sin (y).
d. Multiply the bin value (a+jb) by z.

Comments regarding Step 419:

The phase angle rotation applied in the encoder is the inverse of the angle derived from the Subband Angle Control Parameter.

Phase angle adjustments, as described herein, in an encoder or encoding process prior to downmixing (Step 420) have several advantages: (1) they minimize cancellations of the channels that are summed to a mono composite signal, (2) they minimize reliance on energy normalization (Step 421), and (3) they precompensate the decoder inverse phase angle rotation, thereby reducing aliasing.

The phase correction factors can be applied in the encoder by subtracting each subband phase correction value from the angles of each transform bin value in that subband. This is equivalent to multiplying each complex bin value by a complex number with a magnitude of 1.0 and an angle equal to the negative of the phase correction factor. Note that a complex number of magnitude 1, angle A is equal to cos(A)+j sin(A). This latter quantity is calculated once for each subband of each channel, with A=-phase correction for this subband, then multiplied by each bin complex signal value to realize the phase shifted bin value.

The phase shift is circular, which is benign for continuous signals, but may cause blurring of transients if different phase angles are used for different subbands, so it may be desirable to employ the Transient Flag. When the Transient Flag is True, the angle calculation results may be overridden, and all subbands in a channel may use the same phase correction factor such as zero or a pseudo-random value.

Step 420. Downmix.

Downmix to mono by adding the corresponding complex transform bins across channels to produce a mono composite channel.

Comments regarding Step 420:

In the encoder, once the transform bins of all the channels have been phase shifted, the channels are summed, bin-by-bin, to create the mono composite audio signal.

Step 421. Normalize.

To avoid cancellation of isolated bins and over-emphasis of in-phase signals, normalize the amplitude of each bin of the mono composite channel to have substantially the same energy as the sum of the contributing energies, as follows:
a. Let x=the sum across channels of bin energies (i.e., the squares of the bin magnitudes computed in Step 403).
b. Let y=energy of corresponding bin of the mono composite channel, calculated as per Step 403.
c. Let z=scale factor=square_root (x/y). If x=0 then y is 0 and z is set to 1.
d. Limit z to a maximum value of, for example, 100. If z is initially greater than 100 (implying strong cancellation from downmixing), add an arbitrary value, for example, 0.01*square_root (x) to the real and imaginary parts of the mono composite bin, which will assure that it is large enough to be normalized by the following step.
e. Multiply the complex mono composite bin value by z.

Comments regarding Step 421:

Although it is generally desirable to use the same phase factors for both encoding and decoding, even the optimal choice of a subband phase correction value may cause one or more audible spectral components within the subband to be cancelled during the encode downmix process because the phase shifting of step 419 is performed on a subband rather than a bin basis. In this case, a different phase factor for isolated bins in the encoder may be used if it is detected that the sum energy of such bins is much less than the energy sum of the individual channel bins at that frequency. It is generally not necessary to apply such an isolated correction factor to the decoder, inasmuch as isolated bins usually have little effect on overall image quality.

Step 422. Assemble and Pack into Bitstream(s).

The Amplitude Scale Factors, Angle Control Parameters, Decorrelation Scale Factors, and Transient Flags side channel information for each channel, along with the common mono composite audio are multiplexed as may be desired and packed into one or more bitstreams suitable for the storage, transmission or storage and transmission medium or media.

Comment regarding Step 422:

The mono composite audio may be applied to a data-rate reducing encoding process or device such as, for example, a perceptual encoder or to a perceptual encoder and an entropy coder (e.g., arithmetic or Huffman coder) (sometimes referred to as a “lossless” coder) prior to packing. Also, as mentioned above, the mono composite audio and related sidechain information may be derived from multiple input channels only for audio frequencies above a certain frequency (a “coupling” frequency). In that case, the audio frequencies below the coupling frequency in each of the multiple input channels may be stored, transmitted or stored and transmitted as discrete channels or may be combined or processed in some manner other than as described herein. A type of such arrangements is set forth in the examples of FIGS. 10, 11 and 12, described below. Discrete or otherwise-combined channels may also be applied to a data reducing encoding process or device such as, for example, a perceptual encoder or a perceptual encoder and an entropy encoder. The mono composite audio and the discrete multichannel audio may all be applied to an integrated perceptual encoding or perceptual and entropy encoding process or device prior to packing.

Decoding

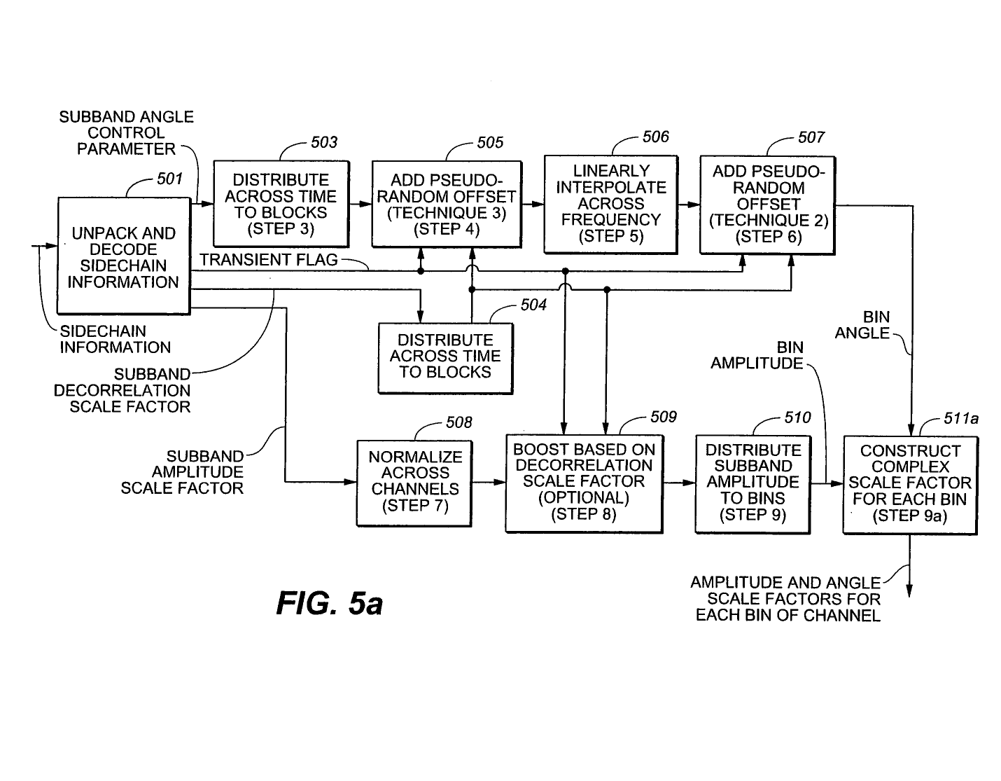

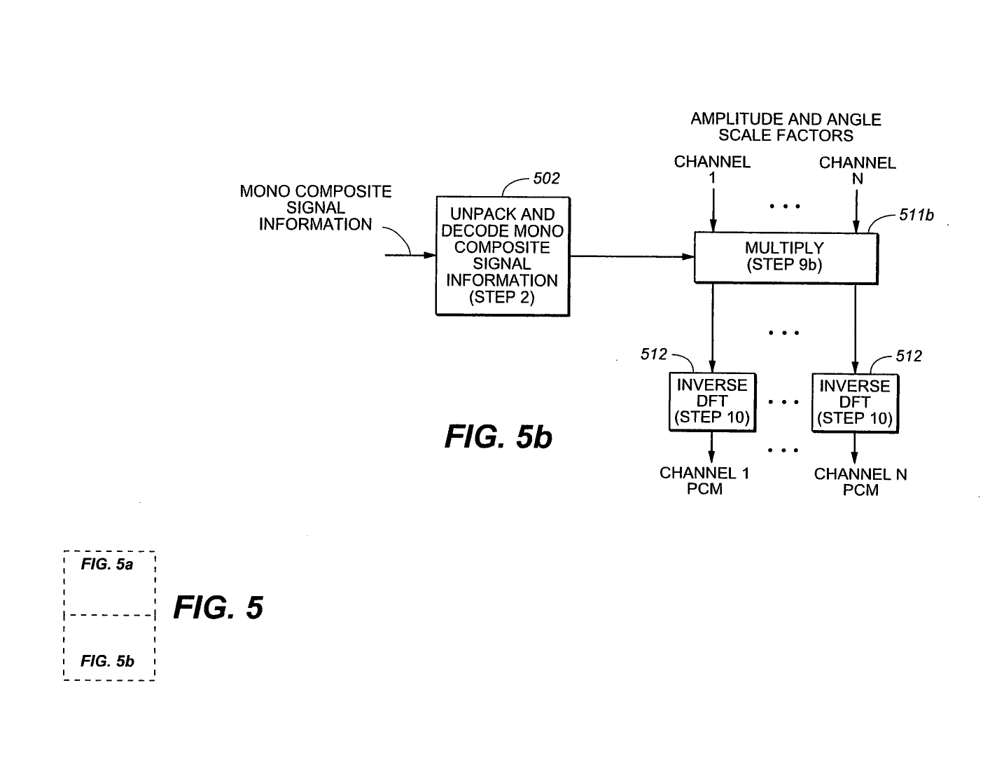

The steps of a decoding process (“decoding steps”) may be described as follows. With respect to decoding steps, reference is made to FIG. 5, which is in the nature of a hybrid flowchart and functional block diagram. For simplicity, the figure shows the derivation of amplitude and scale factors from sidechain information for one channel, it being understood that amplitude and scale factors must be obtained for each channel.

Step 501. Unpack and Decode Sidechain Information.

Unpack and decode (including dequantization), as necessary, the sidechain data (Amplitude Scale Factors, Angle Control Parameters, Decorrelation Scale Factors, and Transient Flag) for each frame of each channel (one channel shown in FIG. 5). Table lookups may be used to decode the Amplitude Scale Factors, Angle Control Parameter, and Decorrelation Scale Factors.

Comment regarding Step 501: As explained above, if a reference channel is employed, the sidechain data for the reference channel may not include the Angle Control Parameters and Decorrelation Scale Factors.

Step 502. Unpack and Decode Mono Composite Signal.

Unpack and decode, as necessary, the mono composite signal information to provide DFT coefficients for each transform bin of the mono composite signal.

Comment regarding Step 502:

Step 501 and Step 502 may be considered to be part of a single unpacking and decoding step.

Step 503. Distribute Angle Parameter Values Across Blocks.

Block Subband Angle Control Parameter values are derived from the dequantized frame Subband Angle Control Parameter values.

Comment regarding Step 503:

Step 503 may be implemented by distributing the same parameter value to every block in the frame.

Step 504. Distribute Subband Decorrelation Scale Factor Across Blocks.

Block Subband Decorrelation Scale Factor values are derived from the dequantized frame Subband Decorrelation Scale Factor values.

Comment regarding Step 504:

Step 504 may be implemented by distributing the same scale factor value to every block in the frame.

Step 505. Add Pseudo-Random Offset (Technique 3).

In accordance with Technique 3, described above, when the Transient Flag indicates a transient, add to the block Subband Angle Control Parameter provided by Step 503 a pseudo-random offset value scaled by the Decorrelation Scale Factor (the scaling may be indirect as set forth in this Step):
a. Let y=block Subband Decorrelation Scale Factor.
b. Let z=y^{exp}, where exp is a constant, for example=5. z will also be in the range of 0 to 1, but skewed toward 0, reflecting a bias toward low levels of pseudo-random variation unless the Decorrelation Scale Factor value is high.
c. Let x=a pseudo-random number between +1 and −1, chosen separately for each subband of each block.
d. Then the value added to the block Subband Angle Control Parameter to add a pseudo-random offset value according to Technique 3 is x*pi*z.

Comments regarding Step 505:

Although the non-linear indirect scaling of Step 505 has been found to be useful, it is not critical and other suitable scalings may be employed—in particular other values for the exponent may be employed to obtain similar results.

When the Subband Decorrelation Scale Factor value is 1, a full range of random angles from −π to +π are added (in which case the block Subband Angle Control Parameter values produced by Step 503 are rendered irrelevant). As the Subband Decorrelation Scale Factor value decreases toward zero, the pseudo-random angle offset also decreases zero, causing the output of Step 505 to move toward the Subband Angle Control Parameter values produced by Step 503.

If desired, the encoder described above may also add a scaled pseudo-random offset in accordance with Technique 3 to the angle shift applied to a channel before mono downmixing. Doing so may improve alias cancellation in the decoder. It may also be beneficial for improving the synchronicity of the encoder and decoder.

Step 506. Linearly Interpolate Across Frequency.

Derive bin angles from the block subband angles of decoder Step 503 to which pseudo-random offsets may have been added by Step 505 when the Transient Flag indicates a transient.

Comments regarding Step 506:

Bin angles may be derived from subband angles by linear interpolation across frequency as described above in connection with encoder Step 418.

Step 507. Add Pseudo-Random Offset (Technique 2).

In accordance with Technique 2, described above, when the Transient Flag does not indicate a transient, for each bin, add to all the block Subband Angle Control Parameters in a frame provided by Step 503 (Step 505 operates only when the Transient Flag indicates a transient) a different pseudo-random offset value scaled by the Decorrelation Scale Factor (the scaling may be direct as set forth herein in this step):
a. Let y=block Subband Decorrelation Scale Factor.
b. Let x=a pseudo-random number between +1 and −1, chosen separately for each bin of each frame.
c. Then the value added to the block bin Angle Control Parameter to add a pseudo-random offset value according to Technique 3 is x*pi*y.

Comments regarding Step 507:

Although the direct scaling of Step 507 has been found to be useful, it is not critical and other suitable scalings may be employed.

To minimize temporal discontinuities, the unique pseudo-random angle value for each bin of each channel preferably does not change with time. The pseudo-random angle values of all the bins in a subband are scaled by the same Subband Decorrelation Scale Factor value, which is updated at the frame rate. Thus, when the Subband Decorrelation Scale Factor value is 1, a full range of random angles from −π to +π are added (in which case block subband angle values derived from the dequantized frame subband angle values are rendered irrelevant). As the Subband Decorrelation Scale Factor value diminishes toward zero, the pseudo-random angle offset also diminishes toward the Subband Angle Control Parameter value. Unlike Step 504, the scaling in this Step 507 may be a direct function of the Subband Decorrelation Scale Factor value. For example, a Subband Decorrelation Scale Factor value of 0.5 proportionally reduces every random angle variation by 0.5.

The scaled pseudo-random angle value may then be added to the bin angle from decoder Step 506. The Decorrelation Scale Factor value is updated once per frame. In the presence of a Transient Flag for the frame, this step is skipped, to avoid transient prenoise artifacts.

If desired, the encoder described above may also add a scaled pseudo-random offset in accordance with Technique 2 to the angle shift applied before mono downmixing. Doing so may improve alias cancellation in the decoder. It may also be beneficial for improving the synchronicity of the encoder and decoder.

Step 508. Normalize Amplitude Scale Factors.

Normalize Amplitude Scale Factors across channels so that they sum-square to 1.

Comment regarding Step 508:

For example, if two channels have dequantized scale factors of −3.0 dB (=2* granularity of 1.5 dB) (0.70795), the sum of the squares is 1.002. Dividing each by the square root of 1.002=1.001 yields two values of 0.7072 (−3.01 dB).

Step 509. Boost Subband Scale Factor Levels (Optional).

Optionally, when the Transient Flag indicates no transient, apply a slight additional boost to Subband Scale Factor levels, dependent on Subband Decorrelation Scale Factor levels: multiply each normalized Subband Amplitude Scale Factor by a small factor (e.g., 1+0.2*Subband Decorrelation Scale Factor). When the Transient Flag is True, skip this step.

Comment regarding Step 509:

This step may be useful because the decoder decorrelation Step 507 may result in slightly reduced levels in the final inverse filterbank process.

Step 510. Distribute Subband Amplitude Values Across Bins.

Step 510 may be implemented by distributing the same subband amplitude scale factor value to every bin in the subband.

Step 511. Upmix.
a. For each bin of each output channel, construct a complex upmix scale factor from the amplitude of decoder Step 508 and the bin angle of decoder Step 507: (amplitude*(cos (angle)+j sin (angle)).
b. For each output channel, multiply the complex mono composite bin value and the complex upmix scale factor to produce the upmixed complex output bin value of each bin of the channel.

Step 512. Perform Inverse DFT (Optional).

Optionally, perform an inverse DFT transform on the bins of each output channel to yield multichannel output PCM values.

Comments regarding Step 512:

A decoder according to the present invention may not provide PCM outputs. In the case where the decoder process is employed only above a given coupling frequency, and discrete MDCT coefficients are sent for each channel below that frequency, as might occur in practical implementations of the examples of FIGS. 10, 11 and 12, as described below, it may be desirable to convert the DFT coefficients derived by the decoder upmixing Step 11 to MDCT coefficients, so that they can be combined with the lower frequency discrete MDCT coefficients and requantized in order to provide, for example, a bitstream compatible with an encoding system that has a large number of installed users, such as a standard AC-3 SP/DIF bitstream for application to an external device where an inverse transform may be performed. An inverse DFT transform may be applied to ones of the output channels to provide PCM outputs.

Section 8.2.2 of the A/52A Document With Sensitivity Factor “F” Added 8.2.2. Transient Detection

Transients are detected in the full-bandwidth channels in order to decide when to switch to short length audio blocks to improve pre-echo performance. High-pass filtered versions of the signals are examined for an increase in energy from one sub-block time-segment to the next. Sub-blocks are examined at different time scales. If a transient is detected in the second half of an audio block in a channel that channel switches to a short block. A channel that is block-switched uses the D45 exponent strategy.

The transient detector is used to determine when to switch from a long transform block (length 512), to the short block (length 256). It operates on 512 samples for every audio block. This is done in two passes, with each pass processing 256 samples. Transient detection is broken down into four steps: 1) high-pass filtering, 2) segmentation of the block into submultiples, 3) peak amplitude detection within each sub-block segment, and 4) threshold comparison. The transient detector outputs a flag blksw[n] for each full-bandwidth channel, which when set to “one” indicates the presence of a transient in the second half of the 512 length input block for the corresponding channel.
1) High-pass filtering: The high-pass filter is implemented as a cascaded biquad direct form II IIR filter with a cutoff of 8 kHz.
2) Block Segmentation: The block of 256 high-pass filtered samples are segmented into a hierarchical tree of levels in which level 1 represents the 256 length block, level 2 is two segments of length 128, and level 3 is four segments of length 64.
3) Peak Detection: The sample with the largest magnitude is identified for each segment on every level of the hierarchical tree. The peaks for a single level are found as follows:
   P[j][k]=max(x(n))
   for n=(512×(k−1)/2̂j), (512×(k−1)/2̂j)+1, . . . (512×k/2̂j)−1
   and k=1, . . . , 2̂(j−1);
   where:
      x(n)=the nth sample in the 256 length block
      j=1, 2, 3 is the hierarchical level number
      k=the segment number within level j
   Note that P[j][0], (i.e., k=0) is defined to be the peak of the last segment on level j of the tree calculated immediately prior to the current tree. For example, P[3][4] in the preceding tree is P[3][0] in the current tree.
4) Threshold Comparison: The first stage of the threshold comparator checks to see if there is significant signal level in the current block. This is done by comparing the overall peak value P[1][1] of the current block to a “silence threshold”. If P[1][1] is below this threshold then a long block is forced. The silence threshold value is 100/32768. The next stage of the comparator checks the relative peak levels of adjacent segments on each level of the hierarchical tree. If the peak ratio of any two adjacent segments on a particular level exceeds a pre-defined threshold for that level, then a flag is set to indicate the presence of a transient in the current 256 length block. The ratios are compared as follows:
   mag(P[j][k])×T[k])×T[j]>(F*mag(P[j][(k−1)])) [Note the “F” sensitivity factor]
   where: T[j] is the pre-defined threshold for level j, defined as:
      T[1]=0.1
      T[2]=0.075
      T[3]=0.05
   If this inequality is true for any two segment peaks on any level, then a transient is indicated for the first half of the 512 length input block. The second pass through this process determines the presence of transients in the second half of the 512 length input block.

Downmixing Applications

The downmixing described above, which is an aspect of the present invention, is useful in many situations in which it is desired to reduce the number of channels of a multichannel audio signal. In such situations, some or all of the channels of content are combined or mixed. As described above, channel combining may cause coupling cancellation artifacts. The above-described downmixing provides for the combining of channels with reduced or inaudible artifacts.

The mono composite audio signal output of the exemplary embodiment of FIG. 1 (a frequency-domain representation) may be passed through an inverse filterbank if it is desired to provide a time-domain representation. In either case, the mono composite output signal is an improved combination of the input channel signals. Whether the input and output signals are time- or frequency-domain representations is not important.

One application of downmixing according to aspects of the present invention is the playback of 5.1 channel content in a motor vehicle. Motor vehicles may reproduce only four channels of 5.1 channel content, corresponding approximately to the Left, Right, Left Surround and Right Surround channels of such a system. Each channel is directed to one or more loudspeakers located in positions deemed suitable for reproduction of directional information associated with the particular channel. However, motor vehicles usually do not have a center loudspeaker position for reproduction of the Center channel in such a 5.1 playback system. To accommodate this situation, it is known to attenuate the Center channel signal (by 3 dB or 6 dB, for example) and to combine it with each of the Left and Right channel signals to provide a phantom center channel. However, such simple combining leads to artifacts previously described.

Instead of applying a simple combining, downmixing according to aspects of the present invention may be applied. For example, the arrangement of FIG. 1 may be applied twice, once for combining the Left and Center signals, and once for combining Center and Right signals. In such a case, in which the downmixing is employed in a reproduction environment, it is, of course, not necessary for the audio analyzers 12 and 14 of FIG. 1 to produce any sidechain information. However, it may still be beneficial to attenuate the Center channel signal by, for example, 3 dB or 6 dB (6 dB may be more appropriate than 3 dB in the near-field space of a motor vehicle interior) before combining it with each of the Left Channel and Right Channels signals so that acoustical power output from the Center channel signal is approximately the same as it would be if presented through a dedicated Center channel speaker. Furthermore, it may be beneficial to denote the Center signal as the reference channel when combining it with each of the Left Channel and Right Channel signals such that the Rotate Angle (8 or 10), to which the Center channel signal is applied, does not alter the angles of the Center channel but only alters the angles of the Left channel and the Right channel signals. Consequently, the Center channel signal would not be angle adjusted differently in each of the two summations (i.e., the Left channel plus Center channel signals summation and the Right channel plus Center channel signals summation), thus ensuring that the phantom Center channel image remains stable.

Another application of the downmixing according to aspects of the present invention is in the playback of multichannel audio in a cinema (motion picture theater). Standards under development for the next generation of digital cinema systems require the delivery of up to, and soon to be more than, 16 channels of audio. The majority of installed cinema systems only provide 5.1 playback or presentation channels (as is well known, the “0.1” represents the low frequency “effects” channel). Therefore, until the playback systems are upgraded, at significant expense, there is the need to downmix content with more than 5.1 channels to 5.1 channels. Such downmixing or combining of channels leads to artifacts as discussed above.

Therefore, if P channels are to be downmixed to Q channels (where P>Q) the downmixing according to aspects of the present invention (e.g., as in the exemplary embodiment of FIG. 1, but with no requirement to provide sidechain information signals) may be applied to obtain one or more of the Q output channels in which each such output channel is to a combination of two or more of respective ones of the P input channels. If an input channel is combined into more than one output channel, it may be advantageous to denote such a channel as a reference channel, such that the Rotate Angle in FIG. 1 does not alter the angles of such an input channel differently for each output channel into which it is combined.

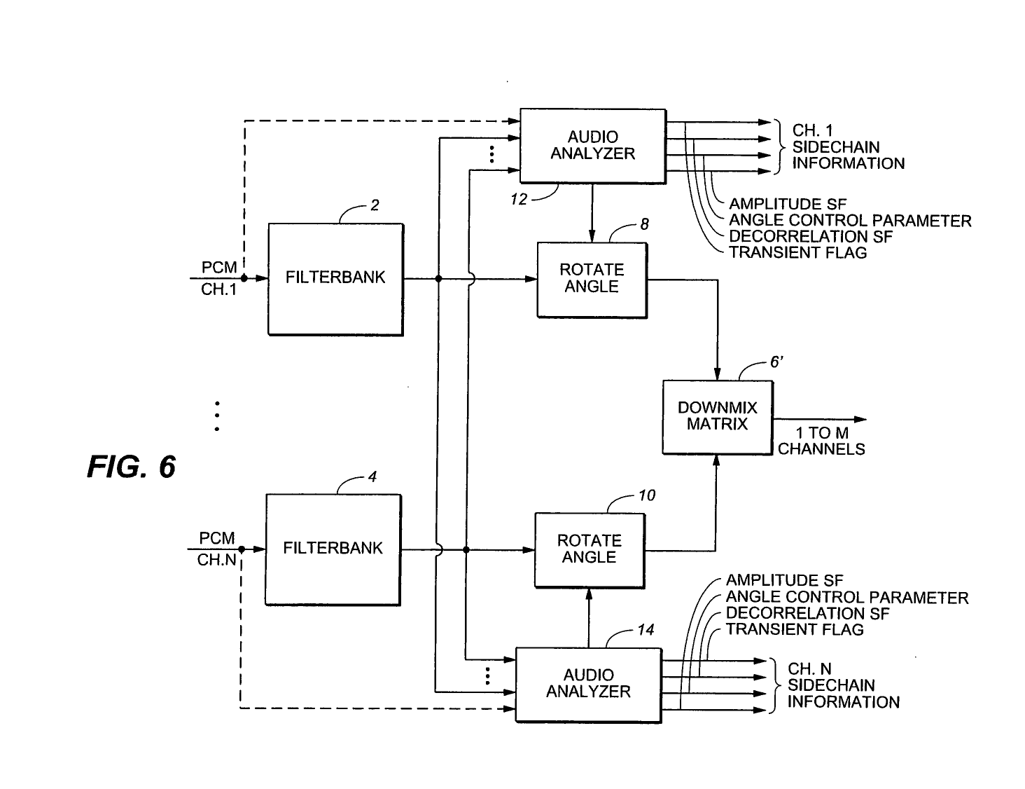

Aspects of the present invention are not limited to N:1 encoding as described in connection with FIG. 1. More generally, aspects of the invention are applicable to the transformation of any number of input channels (n input channels) to any number of output channels (m output channels) in the manner of FIG. 6 (i.e., N:M encoding). Because in many common applications the number of input channels n is greater than the number of output channels m, the N:M encoding arrangement of FIG. 6 will be referred to as “downmixing” for convenience in description.

Referring to the details of FIG. 6, instead of summing the outputs of rotate angle 8 and rotate angle 10 in the additive combiner 6 as in the arrangement of FIG. 1, those outputs may be applied to a downmix matrix device or function 6′. Downmix matrix 6′ may be either a passive matrix that provides a simple summation to one channel, as in the N:1 encoding of FIG. 1, or to multiple channels. Matrix 6′ should have the quality that it provides only positive addition. The matrix coefficients may be real or complex (real and imaginary). Other devices and functions in FIG. 6 may be the same as in the FIG. 1 arrangement and they bear the same reference numerals.

Downmix matrix 6′ may provide a hybrid frequency-dependent function such that it provides, for example, m_{f1-f2} channels in a frequency range f1 to f2 and m_{f2-f3} channels in a frequency range f2 to f3. For example, below a coupling frequency of, for example, 1000 Hz the downmix matrix 6′ may provide two channels and above the coupling frequency the downmix matrix 6′ may provide one channel. By employing two channels below the coupling frequency, better spatial fidelity may be obtained, especially if the two channels represent horizontal directions (to match the horizontality of the human ears). Such a hybrid mono/stereo arrangement is further described below in connection with the examples of FIGS. 10, 11 and 12.

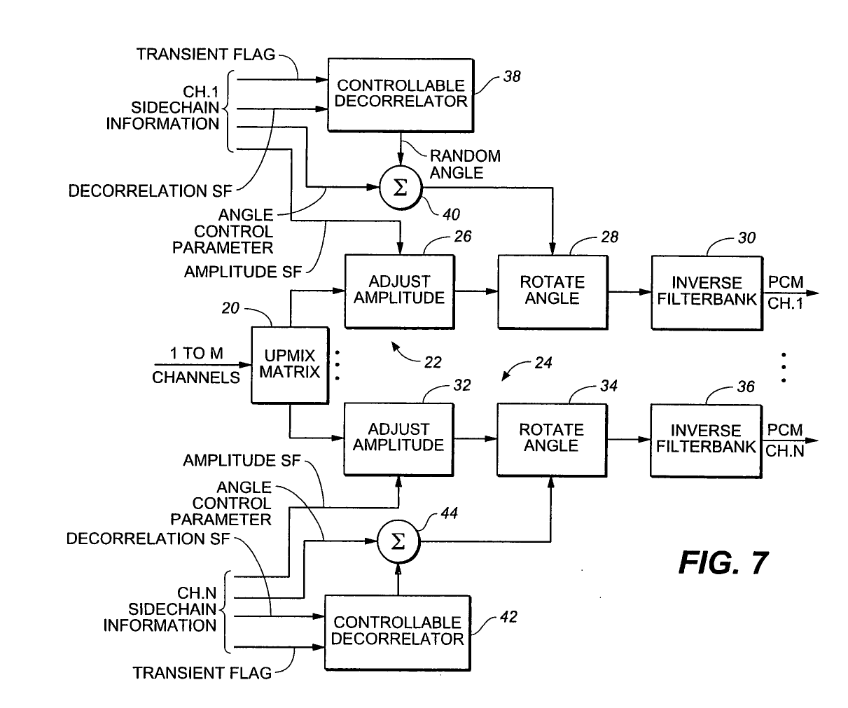

Although FIG. 6 shows the generation of the same sidechain information for each channel as in the FIG. 1 arrangement, it may be possible to omit certain ones of the sidechain information when more than one channel is provided by the output of the downmix matrix 6′. In some cases, acceptable results may be obtained when only the amplitude scale factor sidechain information is provided by the FIG. 6 arrangement. Further details regarding sidechain options are discussed below in connection with the descriptions of FIGS. 7, 8 and 9.

As just mentioned above, the multiple channels generated by the downmix matrix 6′ need not be fewer than the number of input channels n. When the purpose of an encoder such as in FIG. 6 is to reduce the number of bits for transmission or storage, it is likely that the number of channels produced by downmix matrix 6′ will be fewer than the number of input channels n. However, the arrangement of FIG. 6 may also be used as a “downmixer” as described above in connection with FIG. 1. In that case, there may be applications in which the number of channels m produced by the downmix matrix 6′ is more than the number of input channels n.

A more generalized form of the arrangement of FIG. 2 is shown in FIG. 7, wherein an upmix matrix 20 receives the 1 to m channels generated by the arrangement of FIG. 6. The upmix matrix 20 may be a passive matrix that is the conjugate transposition of the downmix matrix 6′ of the FIG. 6 arrangement. In principle, the upmix matrix 20 may be a variable matrix or a passive matrix in combination with a variable matrix in which the variable matrix coefficients are controlled directly or indirectly by the sidechain information. Other elements of FIG. 7 are as in the arrangement of FIG. 2 and bear the same reference numerals.

Alternative Decorrelation

FIGS. 8 and 9 show variations on the generalized decoder of FIG. 7. In particular, both the arrangement of FIG. 8 and the arrangement of FIG. 9 show alternatives to the decorrelation technique of FIGS. 2 and 7. In FIG. 8, respective decorrelators 46 and 48 are in the PCM domain, each following the respective inverse filterbank 30 and 36 in their channel. In FIG. 9, respective decorrelators 50 and 52 are in the frequency domain, each preceding the respective inverse filterbank 30 and 36 in their channel. In both the FIG. 8 and FIG. 9 arrangements, each of the decorrelators has a unique characteristic so that their outputs are mutually decorrelated with respect to each other. The Decorrelation Scale Factor may be used to control, for example, the ratio of decorrelated to uncorrelated signal provided in each channel. Optionally, the Transient Flag may also be used to shift the mode of operation of the decorrelator, as is explained below. In both the FIG. 8 and FIG. 9 arrangements, each decorrelator may be a Schroeder-type reverberator having its own unique filter characteristic, in which the degree of reverberation is controlled by the decorrelation scale factor (implemented, for example, by controlling the degree to which the decorrelator output forms a part of a linear combination of the decorrelator input and output). Alternatively, other controllable decorrelation techniques may be employed either alone or in combination with each other or with a Schroeder-type reverberator. Schroeder-type reverberators are well known and may trace their origin to two journal papers: “‘Colorless’ Artificial Reverberation” by M. R. Schroeder and B. F. Logan, IRE Transactions on Audio, vol. AU-9, pp. 209-214, 1961 and “Natural Sounding Artificial Reverberation” by M. R. Schroeder, Journal A. E. S., July 1962, vol. 10, no. 2, pp. 219-223.

When the decorrelators 46 and 48 operate in the PCM domain, as in the FIG. 8 arrangement, a single Decorrelation Scale Factor is required. This may be obtained by any of several ways. For example, only a single Decorrelation Scale Factor may be generated in the encoder of FIG. 1 or FIG. 7. Alternatively, if the encoder of FIG. 1 or FIG. 7 generates Decorrelation Scale Factors on a subband basis, the Subband Decorrelation Scale Factors may be amplitude or power summed in the encoder of FIG. 1 or FIG. 7 or in the decoder of FIG. 8.

When the decorrelators 50 and 52 operate in the frequency domain, as in the FIG. 9 arrangement, they may receive a decorrelation scale factor for each subband or groups of subbands and, concomitantly, provide a commensurate degree of decorrelation for such subbands or groups of subbands.

The decorrelators 46 and 48 of FIG. 8 and the decorrelators 50 and 52 of FIG. 9 may optionally receive the transient flag. In the PCM domain decorrelators of FIG. 8, the transient flag may be employed to shift the mode of operation of the respective decorrelator. For example, the decorrelator may operate as a Schroeder-type reverberator in the absence of the transient flag but upon its receipt and for a short subsequent time period, say 1 to 10 milliseconds, operate as a fixed delay. Each channel may have a predetermined fixed delay or the delay may be varied in response to a plurality of transients within a short time period. In the frequency domain decorrelators of FIG. 9, the transient flag may also be employed to shift the mode of operation of the respective decorrelator. However, in this case, the receipt of a transient flag may, for example, trigger a short (several milliseconds) increase in amplitude in the channel in which the flag occurred.

As mentioned above, when two or more channels are sent in addition to sidechain information, it may be acceptable to reduce the number of sidechain parameters. For example, it may be acceptable to send only the amplitude scale factor, in which case the decorrelation and angle devices or functions in the decoder may be omitted (in that case, FIGS. 7, 8 and 9 reduce to the same arrangement).

Alternatively, only the amplitude scale factor, the decorrelation scale factor, and, optionally, the transient flag may be sent. In that case, either the FIG. 8 or 9 arrangements would be employed (omitting the rotate angle 28 and 34 in each of them) because the FIG. 7 arrangement also requires the angle control parameter.

As another alternative, only the amplitude scale factor and the angle control parameter may be sent. In that case, either the FIG. 8 or 9 arrangements would be employed (omitting the decorrelator 46, 48, 50, 52 in each of them) because the FIG. 7 arrangement also requires the decorrelation scale factor.

As in FIGS. 1 and 2, the arrangements of FIGS. 6-9 are intended to show any number of input and output channels although, for simplicity in presentation, only two channels are shown.

As mentioned above in connection with the description of the examples of FIGS. 1, 2, and 6 through 9, aspects of the invention are also useful for improving the performance of a low bit rate encoding/decoding system in which a discrete two-channel stereophonic (“stereo”) input audio signal, which may have been downmixed from more than two channels, is encoded, such as by perceptual encoding, transmitted or stored, decoded, and reproduced in two channels as a discrete stereo audio signal below a coupling frequency fₘ and, generally, as a monophonic (“mono” audio signal above the frequency fₘ (in other words, there is substantially no stereo channel separation in the two channels at frequencies above fₘ—they both carry essentially the same audio information). The result is what may be called a “hybrid mono/stereo” signal. By combining the stereo input channels at frequencies above the coupling frequency fₘ, fewer bits need be transmitted or stored. By employing a suitable coupling frequency, the reproduced hybrid mono/stereo signal may provide acceptable performance depending on the audio material and the perceptiveness of the listener. As mentioned above in connection with the description of the example of FIGS. 1 and 6, a coupling or transition frequency as low as 2300 Hz or even 1000 Hz may be suitable but that the coupling frequency is not critical . Another possible choice for a coupling frequency is 4 kHz. Other frequencies may provide a useful balance between bit savings and listener acceptance and the choice of a particular coupling frequency is not critical to the invention. The coupling frequency may be variable and, if variable, it may depend, for example, directly or indirectly on input signal characteristics.

Although such a system may provide acceptable results for most musical material and most listeners, it may be desirable to improve the performance of such a system provided that such improvements are backward compatible and do not render obsolete or unusable an installed base of “legacy” decoders designed to receive such hybrid mono/stereo signals. Such improvements may include, for example, additional reproduced channels, such as “surround sound” channels. Although surround sound channels can be derived from a two-channel stereo signal by means of an active matrix decoder, many such decoders employ wideband control circuits that operate properly only when the signals applied to them are stereo throughout the signals' bandwidth—such decoders do not operate properly under some signal conditions when a hybrid mono/stereo signal is applied to them.

For example, in a 2:5 (two channels in, five channels out) matrix decoder that provides channels representing front left, front center, front right, left (rear/side) surround and right (rear/side) surround direction outputs and steers its output to the front center when essentially the same signal is applied to its inputs, a dominant signal above the frequency fₘ (hence, a mono signal in a hybrid mono/stereo system) may cause all of the signal components, including those below the frequency fₘ that may be simultaneously present, to be reproduced by the center front output. Such matrix decoder characteristics may result in sudden signal location shifts when the dominant signal shifts from above fₘ to below fₘ or vice-versa.

Examples of active matrix decoders that employ wideband control circuits include Dolby Pro Logic and Dolby Pro Logic II decoders. “Dolby” and “Pro Logic” are trademarks of Dolby Laboratories Licensing Corporation. Aspects of Pro Logic decoders are disclosed in U.S. Pat. Nos. 4,799,260 and 4,941,177, each of which is incorporated by reference herein in its entirety. Aspects of Pro Logic II decoders are disclosed in pending U.S. patent application Ser. No. 09/532,711 of Fosgate, entitled “Method for Deriving at Least Three Audio Signals from Two Input Audio Signals,” filed Mar. 22, 2000 and published as WO 01/41504 on Jun. 7, 2001, and in pending U.S. patent application Ser. No. 10/362,786 of Fosgate et al, entitled “Method for Apparatus for Audio Matrix Decoding,” filed Feb. 25, 2003 and published as US 2004/0125960 A1 on Jul. 1, 2004. Each of said applications is incorporated by reference herein in its entirety. Some aspects of the operation of Dolby Pro Logic and Pro Logic II decoders are explained, for example, in papers available on the Dolby Laboratories' website (www.dolby.com): “Dolby Surround Pro Logic Decoder Principles of Operation,” by Roger Dressler, and “Mixing with Dolby Pro Logic II Technology, by Jim Hilson. Other active matrix decoders are known that employ wideband control circuits and derive more than two output channels from a two-channel stereo input.

Aspects of the present invention are not limited to the use of Dolby Pro Logic or Dolby Pro Logic II matrix decoders. Alternatively, the active matrix decoder may be a multiband active matrix decoder such as described in International Application PCT/US02/03619 of Davis, entitled “Audio Channel Translation,” designating the United States, published Aug. 15, 2002 as WO 02/063925 A2 and in International Application PCT/US2003/024570 of Davis, entitled “Audio Channel Spatial Translation,” designating the United States, published Mar. 4, 2004 as WO 2004/019656 A2. Each of said international applications is hereby incorporated by reference in its entirety. Although, because of its multibanded control such an active matrix decoder when used with a legacy mono/stereo decoder does not suffer from the problem of sudden signal location shifts when the dominant signal shifts from above fₘ to below fₘ or vice-versa (the multiband active matrix decoder operates normally for signal components below the frequency fₘ whether or not there are dominant signal components above the frequency fₘ), such multibanded active matrix decoders do not provide channel multiplication above the frequency fₘ when the input is a mono/stereo signal such as described above.

It would be useful to augment a low bitrate hybrid stereo/mono type encoding/decoding system (such as the system just described or a similar system) so that the mono audio information above the frequency fₘ is augmented so as to approximate the original stereo audio information, at least to the extent that the resulting augmented two-channel audio, when applied to an active matrix decoder, particularly one that employs a wideband control circuit, causes the matrix decoder to operate substantially or more nearly as though the original wideband stereo audio information were applied to it.

As will be described, aspects of the present invention may also be employed to improve the downmixing to mono in a hybrid mono/stereo encoder. Such improved downmixing may be useful in improving the reproduced output of a hybrid mono/stereo system whether or not the above-mentioned augmentation is employed and whether or not an active matrix decoder is employed at the output of a hybrid mono/stereo decoder.

FIG. 10 shows an idealized block diagram showing the principle functions or devices of an augmented mono/stereo encoder or encoding function according to aspects of the invention. A two-channel stereo input is applied to a mono/stereo encoder or encoding function 1002 (“Mono/Stereo Encoder”), the output of which is suitable for decoding by a legacy mono/stereo decoder or decoding function. The Encoder 1002 may employ, for example, perceptual encoding and provides a mono/stereo output, for example, as described above. Such two-channel input and output are each shown with two lines to symbolically represent the two channels, it being understood that multiple channel inputs or outputs represented with multiple lines in drawings herein may be assembled and packed into a single bitstream.

Still referring to FIG. 10, the two-channel stereo input is also applied to a device or function (“Derive Spatial Parameters”) 1004 that derives spatial parameters characterizing the stereo input signals generally above the coupling frequency fₘ. Such spatial parameters may include, for example, interchannel amplitude, and either or both of interchannel phase (or time) difference and interchannel coherence (as measured, for example, by peak cross-correlation). The amount of data required to carry such parameters may be much less than that which would have been required to convey frequencies above a coupling frequency fₘ as two discrete channels rather than as a combined monophonic one. Preferably, such parameters are minimally sufficient to augment the hybrid mono/stereo output of a legacy decoder such that its two-channel characteristics above the coupling frequency fₘ are sufficient to cause a typical wideband-control-circuit matrix decoder to operate substantially as though the original wideband stereo audio information were applied to it. Device or function 1004 generates a low-bitrate spatial-parameter sidechain signal suitable for combining with the bitstream output of the encoder 1002 in a device or function (“Combiner”) 1006. Preferably, the sidechain information is combined so that it is carried in or with the normal hybrid mono/stereo encoder bitstream in such a way that the operation of a legacy mono/stereo decoder receiving such a bitstream is not affected.

The particular manner in which such sidechain information is carried in the encoder bitstream is not critical to the invention. Many known techniques may be suitable. For example, many encoders generate a bitstream having unused or null bits that are ignored by the decoder. An example of such an arrangement is set forth in U.S. Pat. No. 6,807,528 B1 of Truman et al, entitled “Adding Data to a Compressed Data Frame,” Oct. 19, 2004, which patent is hereby incorporated by reference in its entirety. Such bits may be replaced with the sidechain information. Another example is that the sidechain information may be steganographically encoded in the encoder's bitstream. Alternatively, the sidechain information may be stored or transmitted separately from bitstream produced by encoder 1002 by any technique that permits the transmission or storage of such information along with a mono/stereo bitstream compatible with legacy decoders.

FIG. 11 shows an idealized block diagram showing the principle functions or devices of an alternative augmented mono/stereo encoder or encoding function according to aspects of the invention. In the FIG. 11 alternative, in addition to deriving spatial-parameter sidechain information, the two-channel stereo input is processed so that it is in better condition for summing to mono above the coupling frequency fₘ. Such processing may include, for example, adjustment of the relative phase angle above the coupling frequency fₘ between the two input channels so as to reduce cancellation when the channels are summed to mono and, preferably, to avoid cancellation of isolated frequency bins and over-emphasis of in-phase signals, by normalizing the amplitude of each bin of the mono composite channel to have substantially the same energy as the sum of the contributing energies. Thus, FIG. 11 shows a two-channel stereo input suitable for application directly to a mono/stereo encoder or encoding function 1102 (“Mono/Stereo Encoder”), the output of which, in turn, is suitable for decoding by a “legacy” mono/stereo decoder or decoding function. Encoder 1102 may be the same device or function as encoder 1002 of the FIG. 10 arrangement. Instead of being applied directly to encoder 1102, the two-channel stereo input is applied to a device or function (“Pre-Process and Derive Spatial Parameters”) 1100 that pre-processes the two-channel stereo input in order to improve the subsequent downmixing to mono above the frequency fₘ in the hybrid mono/stereo encoder 1102 and that generates a low-bitrate spatial-parameter sidechain-information signal suitable for combining with the bitstream output of the encoder 1102 in a device or function (“Combine”) 1106. Combine 1106 may be the same device or function as Combine 1006 of the FIG. 10 arrangement. Other aspects of the example of FIG. 11 are the same as in example of FIG. 10.

Except for the transmission or storage of the spatial-parameter sidechain information in a manner compatible with legacy decoders, the function of FIGS. 10 and 11 may be implemented, for example, by the encoder of FIG. 6, described above, in which the downmix in block 6′ is such that there are two channels m_{f1-f2} in the frequency range f1 to f2 and one channel m_{f2-f3} in the frequency range f2 to f3, where f1 is the lower frequency limit of the encode/decode arrangement, f2 is the coupling frequency fₘ, and f3 is the upper frequency limit of the encode/decode arrangement.

It will be appreciated that device or function 1100 performs two processes and that it may also be shown as two blocks rather than one. It will also be appreciated that various devices, functions and processes shown and described in various examples herein may be shown combined or separated in ways other than as shown in the figures herein. For example, when implemented by computer software instruction sequences, all of the functions of FIGS. 10 and 11 may be implemented by multithreaded software instruction sequences running in suitable digital signal processing hardware, in which case the various devices and functions in the examples shown in the figures may correspond to portions of the software instructions.

The two-channel stereo inputs in the examples of FIGS. 10 and 11 may be derived from more than two channels. For example, five channels representing front left, front center, front right, left (rear/side) surround and right (rear/side) surround directions may be downmixed to two stereo channels by a suitable encoder (typically a fixed, non-active encoder) whose encoding characteristics are chosen to be complementary to the decoding characteristics of an expected matrix decoder.

As mentioned above, the bitstream produced by the encoding examples of FIGS. 10 and 11 is compatible with a legacy mono/stereo decoder. Thus, one example of a suitable decoding arrangement for such a bitstream is simply a legacy mono/stereo decoder receiving and processing the bitstream (not shown in view of its simplicity). In the case of an encoder such as in the example of FIG. 10, such a legacy decoder will operate as though the encoder produced a bitstream intended for a legacy decoder. In the case of an encoder such as in the example of FIG. 11, such a legacy decoder may operate with improved performance in view of the pre-processing in function or device 1100. Nevertheless, whether the bitstream received by a legacy mono/stereo decoder is produced by an arrangement as in the example of FIG. 10 or FIG. 11, the output of such a legacy decoder remains unsuitable for application to an active matrix decoder, particularly one that employs a wideband control circuit - the output remains mono above the frequency fₘ because a legacy decoder does not recognize or use the spatial parameter sidechain information.

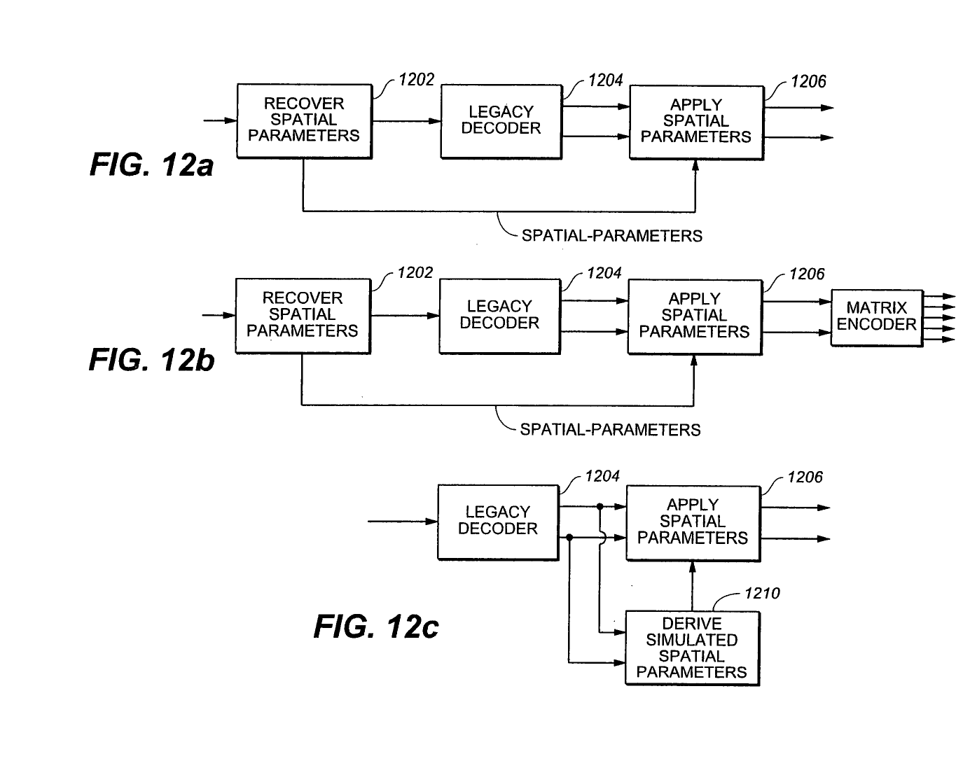

FIG. 12 shows an idealized block diagram showing the principle functions or devices of an augmented mono/stereo decoder or decoding function according to aspects of the invention. A bitstream such as may be generated by an augmented encoder such as in the example of FIG. 10 or FIG. 11 is applied to a device or function (“Recover Spatial Parameters”) 1202 that recovers the spatial parameter sidechain information and provides that information as an output. Recover Spatial Parameters 1202 may either remove that information from the bitstream it receives to provide a further output that is applied to a legacy mono/stereo decoder or decoding function (“Legacy Decoder”) 1204 or it may apply the bitstream it receives unaltered to the decoder 1204 because the legacy decoder will ignore the sidechain information. The mono/stereo output from Legacy Decoder 1204 is applied to a function or device (“Apply Spatial Parameters”) 1206 that applies the spatial parameter sidechain information recovered by device or function 1202 to the two-channel mono/stereo output of the Legacy Decoder 1204 so that the mono audio information above the coupling frequency fₘ is augmented so as to approximate the original stereo audio information, at least to the extent that the resulting augmented two-channel audio, when applied to an active matrix decoder, causes the matrix decoder to operate substantially or more nearly as though the original wideband stereo audio information were applied to it. The augmented two-channel audio information from Apply Spatial Parameters 1206 may then be applied to an active matrix decoder or decoding function (“Active Matrix Decoder”), including those that employ a wideband control circuit, so as to increase the number of channels.

A decoder according to aspects of the invention illustrated in the example of FIG. 12 may be characterized as a “hybrid matrix decoder” for operating in a “hybrid matrix encoder/decoder system.” “Hybrid” in this context refers to the fact that the decoder derives some measure of control information from its input audio signal and a further measure of control information from spatial-parameter sidechain information.

As mentioned above, various devices, functions and processes shown and described in various examples herein may be shown combined or separated in ways other than as shown in the figures. Thus, in the case of the FIG. 12 example, the Legacy Decoder 1204 may be implemented, for example, by a legacy device or function in combination with other devices and functions or its operation may be emulated as part of a device or function that also provides the recovery of and application of spatial parameter functions. Similarly, the active matrix decoder may be implemented as a separate legacy matrix decoder device or function or it may be incorporated with other devices or functions of the FIG. 12 example.

As mentioned above, the functions of the FIGS. 10 and 11 encoders may be implemented, for example, by the encoder of FIG. 6, described above when such an encoder provides for the transmission or storage of the spatial-parameter sidechain information in a manner compatible with legacy decoders. Similarly, the functions of the FIG. 12 decoder may be implemented, for example, by the decoders of any one of the FIGS. 7, 8 and 9 examples when they provide for the recovery of the spatial-parameter sidechain information that was transmitted or stored in a manner compatible with legacy decoders.

An alternative to the arrangements of FIGS. 10, 11 and 12 that also may allow a legacy matrix decoder to operate substantially or more nearly as though the original wideband stereo audio information were applied to it is to send or store no spatial-parameter sidechain information (thus, augmented encoders such as the examples of FIGS. 10 and 11 are not necessary) and to approximate a two-channel stereo signal above the frequency fₘ using the mono signal above that coupling frequency and spatial-parameter information derived from the two-channel stereo signal below the coupling frequency fₘ. Such a decoding arrangement may be represented in the same manner as the example of FIG. 12 with the exception that the Recover Spatial Parameters 1202 does not recover spatial-parameter sidechain information for frequencies above the coupling frequency fₘ from the incoming bitstream as such but instead generates simulated spatial-parameter sidechain information for application to the Apply Spatial Parameters 1206.

Encoders as described in connection with the examples of FIGS. 10 and 11 may also include their own local decoder or decoding function, such as a decoder described in the example of FIG. 11, in order to determine if the two-channel mono/stereo signal and the sidechain information, when decoded by such a decoder, would provide suitable results. The results of such a determination could be used to improve the parameters by employing, for example, a recursive process. In a block encoding and decoding system, as described above, recursion calculations could be performed, for example, on every block before the next block ends in order to minimize the delay in transmitting a block of mono/stereo two-channel audio and its associated spatial parameters.

An arrangement in which the encoder examples of FIGS. 10 and 11 also include their own decoder or decoding function could also be employed advantageously when spatial parameters are not stored or sent only for certain blocks rather than all blocks as in the alternative to the decoder of FIG. 12, described above. If unsuitable decoding would result from not sending spatial-parameter sidechain information, such sidechain information would be sent for the particular block. In this case, the decoder would be a further modification of the decoder or decoding function of FIG. 12 in that the Recover Spatial Parameters 1202 would have both the ability to recover spatial-parameter sidechain information for frequencies above the coupling frequency fₘ from the incoming bitstream but also to generate simulated spatial-parameter sidechain information from the stereo information below the coupling frequency fₘ.

In a simplified alternative to the local-decoder-incorporating encoder examples of FIGS. 10 and 11, rather than having a local decoder or decoder function, the encoder could simply check to determine if there were any signal content below the coupling frequency fₘ (determined in any suitable way, for example, a sum of the energy in frequency bins through the frequency range), and, if not, it would send or store spatial-parameter sidechain information rather than not doing so if the energy were above the threshold. Depending on the encoding scheme, low signal information below the coupling frequency fₘ may also result in more bits being available for sending sidechain information.

It should be understood that implementation of other variations and modifications of the invention and its various aspects will be apparent to those skilled in the art, and that the invention is not limited by these specific embodiments described. It is therefore contemplated to cover by the present invention any and all modifications, variations, or equivalents that fall within the true spirit and scope of the basic underlying principles disclosed herein.

We claim:

1. A hybrid stereophonic/monophonic audio signal encoding method, comprising
generating, in response to a discrete two-channel stereophonic audio signal, an encoded hybrid stereophonic/monophonic audio signal in which the audio signal is a discrete two-channel audio signal below a frequency fₘ and a single-channel monophonic audio signal above the frequency fₘ,
generating, in response to said discrete two-channel stereophonic audio signal, spatial parameter information characterizing the discrete two-channel stereophonic audio signal above the frequency fₘ, and
combining the hybrid stereophonic/monophonic audio signal with said spatial parameter information in such a manner that the resulting signal is decodable both by a decoder configured to decode a discrete two-channel stereophonic audio signal encoded with the same encoding as applied to the hybrid stereophonic/monophonic audio signal and by a decoder configured to decode, with the use of the spatial parameter information, the hybrid stereophonic/monophonic audio signal.

2. A method according to claim 1, wherein said generating a hybrid stereophonic/monophonic audio signal includes combining the channels of the discrete two-channel stereophonic audio signal above the frequency fₘ, the method further comprising preprocessing the channels of the discrete two-channel stereophonic audio signal so that they are in better condition for combining.

3. A method according to claim 2 wherein said processing includes one or both of (a) adjusting the relative phase angle above the frequency fₘ between the two channels so as to reduce cancellation when the channels are combined, and (b) normalizing the amplitude of each bin of the mono composite channel to have substantially the same energy as the sum of the contributing energies so as to avoid cancellation of isolated frequency bins and over-emphasis of in-phase signal.

4. A method according to claim 1, further comprising
recovering spatial parameter information,
applying the spatial parameter information to the hybrid stereophonic/monophonic audio signal audio signal so that the augmented monophonic audio information above the frequency fₘ approximates the original stereophonic audio information, and
determining the degree to which the augmented monophonic information above the frequency fₘ approximates the original stereophonic audio information, and
wherein generating the spatial parameter information is also in response to the degree to which the augmented monophonic information above the frequency fₘ approximates the original stereophonic audio information.

5. A method according to claim 4, wherein generating spatial parameter information is part of a recursive process that includes determining the degree to which the augmented monophonic information above the frequency fₘ approximates the original stereophonic audio information.

6. A method according to claim 1 further comprising storing or sending the combined audio signal and spatial parameter information and wherein said encoded hybrid stereophonic/monophonic audio signal is encoded using a block encoding process and the spatial parameter information is stored or sent for every block.

7. A method according to claim 1 further comprising storing or sending the combined audio signal and spatial parameter information and wherein said encoded hybrid stereophonic/monophonic audio signal is encoded using a block encoding process and the spatial parameter information is not stored or sent for every block.

8. A method according to claim 1 wherein the spatial parameter information is not sent when the signal energy below the frequency fₘ is above a threshold.

9. A method according to claim 1 wherein said discrete two-channel stereophonic audio signal is derived from a multichannel audio signal having more than two channels.

10. A method according to claim 9 wherein said discrete two-channel stereophonic audio signal is derived from a multichannel audio signal having more than two channels using a matrix encoder.

11. A method according to claim 10 wherein said matrix encoder employs a fixed matrix.

12. A hybrid stereophonic/monophonic audio signal decoding method, comprising
recovering spatial parameter information from a combination of an encoded hybrid stereophonic/monophonic audio signal and spatial parameter information,
decoding the encoded hybrid stereophonic/monophonic audio signal to provide an audio signal that is a discrete two-channel below a frequency fₘ and a single-channel monophonic audio signal above the frequency fₘ,
applying the spatial parameter information to the decoded audio signal so that the augmented monophonic audio information above the coupling frequency fₘ approximates the original stereophonic audio information, the approximation including an approximation of the relative phase between the channels, and
deriving more than two channels from the audio approximating the original stereophonic audio information.

13. A method according to claim 12 wherein said more than two channels are derived using a matrix decoder.

14. A hybrid stereophonic/monophonic audio signal decoding method, comprising
decoding the encoded hybrid stereophonic/monophonic audio signal to provide an audio signal that is a discrete two-channel below a frequency fₘ and a single-channel monophonic audio signal above the frequency fₘ,
recovering simulated spatial parameter information for the single-channel monophonic audio signal above the frequency fₘ from the discrete two-channel audio signal below the frequency fₘ, and
applying the simulated spatial parameter information to the decoded audio signal so that the augmented monophonic audio information above the coupling frequency fₘ approximates the original stereophonic audio information.

15. A method according to claim 14 further comprising deriving more than two channels from the audio approximating the original stereophonic audio information.

16. A method according to claim 15 wherein said more than two channels are derived using a matrix decoder.

17. A method according to claim 16 wherein said matrix decoder operates at least in part in response to the relative phase between the channels applied to it.

18. A method according to claim 16 wherein said matrix decoder employs a variable matrix.

19. A method according to claim 18 wherein said matrix decoder operates at least in part in response to the relative phase between the channels applied to it.

20. Apparatus adapted to perform the methods of any one of claims 1, 12 or 14.

21. A computer program, stored on a computer-readable medium for causing a computer to perform the methods of any one of claims 1, 12 or 14.
